(19) United States
(12) Patent Application Publication
(10) Pub. No.: US 2009/0326688 A1
(43) Pub. Date: Dec. 31, 2009

(54) Systems and Methods for Fitting Golfers with Golf Clubs

(75) Inventors: James S. Thomas, Fort Worth, TX (US); Raymond J. Sander, Benbrook, TX (US); Vincent J. Contini, Powell, OH (US); Brad Glenn, Columbus, OH (US); Jeffrey A. Hadden, Worthington, OH (US); Dave Rigsby, Heath, OH (US); George Zivich, Delaware, OH (US)

Correspondence Address: BANNER & WITCOFF, LTD., 1100 13th STREET, N.W., SUITE 1200, WASHINGTON, DC, 20005-4051, US

(73) Assignee: NIKE, INC., Beaverton, OR (US)

(21) Appl. No.: 12/362,272

(22) Filed: Jan. 29, 2009

Related U.S. Application Data
(60) Provisional application No. 61/025,605, filed on Feb. 1, 2008.

(51) Int. Cl. G06F 19/00; A63B 53/00

(52) U.S. Cl. 700/91; 473/409

(57) ABSTRACT

Golf club fitting systems and methods include: (a) receiving input data indicating a golfer's driver loft angle and shaft flexibility characteristic; (b) determining initial candidate fairway wood clubs based on this data; and (c) identifying the initial candidate fairway wood clubs. Such systems and methods further may include: (d) receiving launch monitor data generated when the golfer hits balls using the initial candidate fairway wood clubs; (e) determining and identifying additional candidate fairway wood clubs for testing; (f) receiving launch monitor data generated when the golfer hits balls using the additional candidate fairway wood clubs; and (g) determining and identifying a recommendation for a final first fairway wood club based on the data. Other clubs in the fitted set also may be determined by these fitting systems and methods.

### RELATED APPLICATION DATA

This application claims priority benefits based on U.S. Provisional Patent Appln. No. 61/025,605 filed Feb. 1, 2008. This earlier provisional patent application is entirely incorporated herein by reference.

### FIELD OF THE INVENTION

This invention relates generally to computer-aided systems and methods for fitting golfers with golf clubs better suited to their swings and games. Additional aspects of this invention relate to computer-generated displays and graphical user interfaces that receive input from and/or generate output received by the club fitter and/or the golfer being fit.

### BACKGROUND

Golf is enjoyed by a wide variety of players—players of different genders and dramatically different ages and/or skill levels. Golf is somewhat unique in the sporting world in that such diverse collections of players can play together in golf events, even in direct competition with one another (e.g., using handicapped scoring, different tee boxes, in team formats, etc.), and still enjoy the golf outing or competition. These factors, together with the increased availability of golf programming on television (e.g. golf tournaments, golf news, golf history, and/or other golf programming) and the rise of well known golf superstars, at least in part, have increased golf's popularity in recent years, both in the United States and across the world.

Golfers at all skill levels seek to improve their performance, lower their golf scores, and reach that next performance “level.” Manufacturers of all types of golf equipment have responded to these demands, and in recent years, the industry has witnessed dramatic changes and improvements in golf equipment. For example, a wide range of different golf ball models now are available, with balls designed to complement specific swing speeds and/or other player characteristics or preferences, e.g., with some balls designed to fly farther and/or straighter; some designed to provide higher or flatter trajectories; some designed to provide more spin, control, and/or feel (particularly around the greens); some designed for faster or slower swing speeds; etc. A host of swing and/or teaching aids also are available on the market that promise to help lower one's golf scores.

Being the sole instruments that set a golf ball in motion during play, golf clubs also have been the subject of much technological research and advancement in recent years. For example, the market has seen dramatic changes and improvements in putter designs, golf club head designs, shafts, and grips in recent years. Additionally, other technological advancements have been made in an effort to better match the various elements and/or characteristics of the golf club and characteristics of a golf ball to a particular user's swing features or characteristics (e.g., club fitting technology, ball launch angle measurement technology, ball spin rates, ball fitting technology, etc.).

Given the recent advances, there is a vast array of golf club component parts available to the golfer. For example, club heads are produced by a wide variety of manufacturers in a variety of different models. Moreover, the individual club head models may include multiple variations, such as variations in the loft angle, lie angle, offset features, weighting characteristics (e.g. draw biased club heads, fade biased club heads, neutrally weighted club heads, etc.), and the like. Additionally, the club heads may be combined with a variety of different shafts, e.g. from different manufacturers; having different stiffnesses, flex points, kick points, or other flexion characteristics, etc.; made from different materials; etc. A variety of grip sizes, materials, constructions, and brands also are available. Between the available variations in shafts, club heads, and grips, there are literally hundreds of different club head/shaft/grip combinations available to the golfer.

Club fitters and golf professionals can assist in helping golfers sift through this staggering array of component combinations and in fitting golfers with golf clubs that suit their swing characteristics and needs. Currently, proper club fitting is largely a trial and error procedure, which can be quite time-consuming, and the fitting procedure is largely dependent upon the skill of the professional making the fitting. Advances in club fitting technology that allow the club fitter to easily and more accurately make measurements and properly fit an individual to a club and/or a set of clubs would be welcome in the art.

### SUMMARY

The following presents a general summary of aspects of the invention in order to provide a basic understanding of the invention and various features of it. This summary is not intended to limit the scope of the invention in any way, but it simply provides a general overview of the invention and context for the more detailed description that follows.

Aspects of this invention relate to systems and methods for fitting a golfer with a fitted set of golf clubs (e.g., a set of two or more clubs, and in some instances a complete or substantially complete set of clubs). One such method for fitting a golfer with plural golf clubs includes: (a) fitting a golfer with a driver based, at least in part, on launch monitor data, wherein the driver to which the golfer is fitted includes a first loft angle and a first shaft flexibility characteristic; (b) selecting plural initial candidate fairway wood clubs based, at least in part, on the first loft angle and the first shaft flexibility characteristic; (c) hitting golf balls using the plural initial candidate fairway wood clubs and collecting launch monitor data relating to the hits correlated to the initial fairway wood club used for the hit; (d) optionally, selecting one or more additional candidate fairway wood clubs based, at least in part, on the launch monitor data collected when the initial fairway wood clubs were hit, and hitting golf balls using the one or more additional candidate fairway wood clubs; and (e) providing a recommendation for a final first fairway wood club based on the launch monitor data.

Computer-implemented systems and methods in accordance with examples of this invention may include: (a) receiving input data (e.g., via any desired computer input hardware) indicating a golfer's driver loft angle and at least one driver shaft flexibility characteristic; (b) determining plural initial candidate fairway wood clubs based, at least in part, on the driver loft angle and the driver shaft flexibility characteristic (e.g., utilizing a computer processing system); and (c) outputting data identifying the selected plural initial candidate fairway wood clubs (e.g., via any desired computer operated output hardware). Such systems and methods further may include one or more of the following steps: (d) receiving launch monitor data generated when the golfer hits golf balls using the plural initial candidate fairway wood clubs; (e) determining one or more additional candidate fairway wood clubs for testing based on the launch monitor data received based on the initial candidate fairway wood clubs hits; (f) outputting data identifying the additional candidate fairway wood clubs; (g) receiving launch monitor data generated when the golfer hits golf balls using the one or more additional candidate fairway wood clubs; (h) determining a recommendation for a final first fairway wood club based on the launch monitor data; and (i) outputting data identifying the recommendation for the final first fairway wood club.

Aspects of this invention further may include fitting steps to fit additional clubs, such as irons, hybrids, or additional fairway woods. Accordingly, at least some example systems and methods according to this invention may include: (a) receiving launch monitor data relating to golf ball hits using one or more irons; (b) receiving launch monitor data relating to golf ball hits using a one or more hybrid or fairway wood clubs; (c) determining a desired carry distance or a desired carry distance range for clubs in a fitted set based, at least in part, on an average ball carry distance for at least one of the driver or a first fairway wood club (e.g., optionally, the previously fit clubs described above); (d) determining whether an average ball carry distance of one or more of the irons or the hybrid clubs better matches the desired carry distance or the desired carry distance range for the fitted set; (e) determining a recommendation for inclusion of one or more irons, hybrid clubs, or fairway woods in the fitted set; and (f) outputting data indicating the recommendations. In this manner, the fitter can attempt to fit the golfer with clubs having a regular, stepped carry distance as the golfer uses different clubs in his or her bag.

Additional aspects of this invention relate to computer-readable media including computer-executable instructions stored thereon for performing the various methods and/or operating the various systems described above (and those described in more detail below). Still additional aspects of this invention relate to the computer-generated displays and/or graphical user interfaces used to present information to and/or receive input data from the club fitter, the golfer, or other user in the operation of the various systems and in the performance of the various methods described above.

### BRIEF DESCRIPTION OF THE DRAWINGS

A more complete understanding of aspects of the present invention and certain advantages thereof may be acquired by referring to the following detailed description in consideration with the accompanying drawings, in which:

FIG. 1 illustrates an example launch monitor system that may be used in systems and methods in accordance with this invention;

FIG. 2 illustrates an overview of an example golf club set fitting system and method in accordance with this invention;

FIG. 3 illustrates an example driver fitting procedure that may be used in some example systems and methods in accordance with this invention;

FIGS. 4 through 8 illustrate example display outputs that may be provided in at least some example driver fitting procedures in accordance with this invention;

FIG. 9 illustrates an example first fairway wood fitting procedure that may be used in systems and methods according to at least some examples of this invention;

FIG. 10 illustrates an example shaft length fitting procedure that may be used in systems and methods according to at least some examples of this invention;

FIGS. 11A through 11D help explain various features of the example shaft length fitting procedure of FIG. 10;

FIG. 12 illustrates an example lie angle fitting procedure that may be used in systems and methods according to at least some examples of this invention;

FIGS. 13A through 13C help explain various features of the example lie angle fitting procedure of FIG. 12;

FIGS. 14A and 14B illustrate an example iron, hybrid club, and/or fairway wood fitting procedure that may be used in systems and methods according to at least some examples of this invention;

FIGS. 15 and 16 illustrate example display outputs that may be provided in at least some example iron, hybrid club, and/or fairway wood fitting procedures in accordance with this invention;

FIG. 17A illustrates an example wedge fitting procedure that may be used in systems and methods according to at least some examples of this invention; and

FIG. 17B helps explain various features of the example wedge fitting procedure of FIG. 17A.

### DETAILED DESCRIPTION

In the following description of various example structures in accordance with the invention, reference is made to the accompanying drawings, which form a part hereof, and in which are shown by way of illustration various example golf club fitting systems and methods in accordance with the invention. Additionally, it is to be understood that other specific arrangements of components and/or steps may be utilized, and structural and functional modifications may be made without departing from the scope of the present invention.

A. General Description of Background Information Relating to this Invention

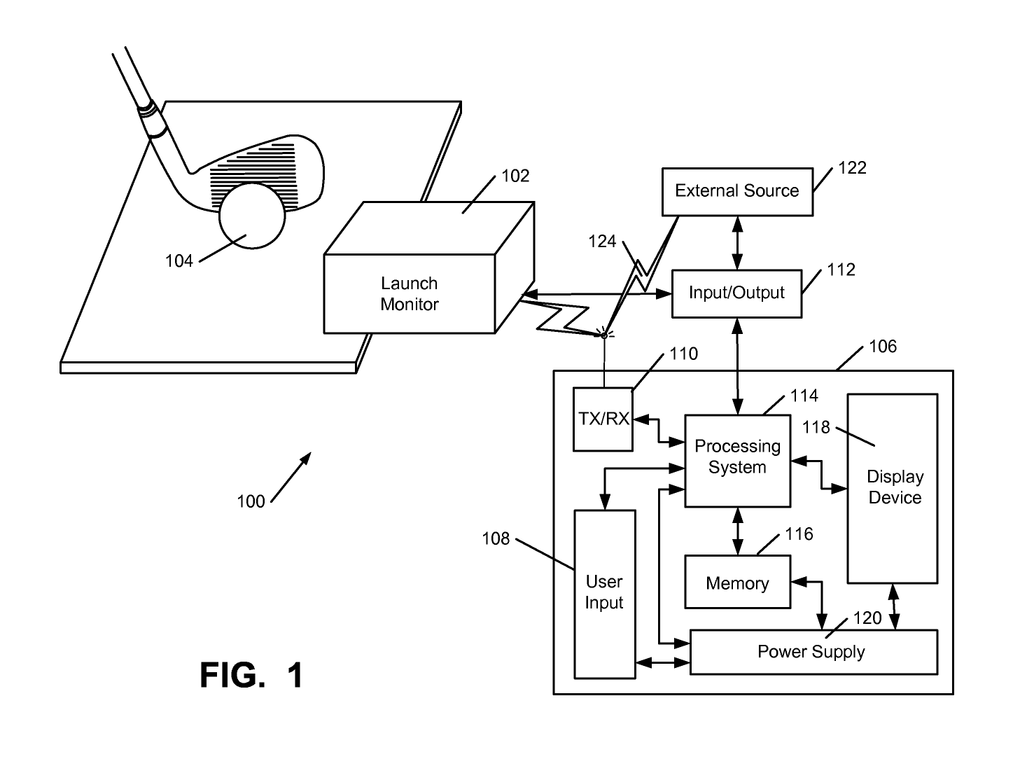

Properly fitting a golfer with clubs suited to his or her swing can help the golfer make better and more consistent contact with the ball during a round of golf and help the golfer reduce his or her score. As described above, aspects of this invention relate to computer-implementable systems and methods for fitting a golfer with one or more golf clubs. FIG. 1 illustrates a schematic diagram of an example fitting system 100 that may be used in accordance with this invention. This example system 100 may include a conventional golf ball launch monitoring system 102 that measures various characteristics of a golf ball's 104 flight, such as the ball's initial velocity, launch direction, spin rates, spin direction(s), club head speed, club head orientation at ball impact, and the like. As is known in the art, the launch monitor 102 may transfer data generated by its sensors to a computing system 106, which may include a conventional personal computer (“PC”), laptop, computer workstation (e.g., connected to a network), or the like. Further, as is known in the art, the computing system 106 may include various elements or features that allow the club fitter to collect, process, and display information obtained from the launch monitor 102, such as a user input system 108, a wireless transmitter/receiver system 110, other input/output systems 112, etc. The user input system 108 may allow the user to enter, control, or adjust settings for the computing system 106 and/or the launch monitor 102 or various components thereof, etc. Any desired type of user input system 102 may be provided without departing from the invention, including, for example, a keyboard input, a mouse input, other “pointer” type inputs (such as a roller ball, track ball, or the like), a stylus type input, a touch pad input, a voice input, a button type input (hard or soft buttons), a soft keyboard input, a scanner input, a universal serial bus or other input port, a parallel port, etc. The computing system 106 further may include its own processing system 114 (e.g. one or more microprocessors), a computer-readable memory system 116, a display device 118 (e.g. a computer monitor, printer, or other output device), and/or a power supply 120 (e.g., AC and/or DC power supply), etc.

Systems and methods in accordance with examples of this invention may receive data, input, and/or other information in other ways as well. For example, as noted above, an input/output system 112 may be provided for receiving data, input, and/or other information from remote or other external sources 122, such as the launch monitor 102, the internet, an external computer-readable memory element, etc. The input/output system 112 may be any desired type of input/output interface device for receiving data, such as a disk drive (e.g., read/write systems for floppy disks, CDs, DVDs, etc.); a USB port; an Ethernet, telephone, or other wired connection port or system; etc. Similarly, the external source 122 may be a disk, flash drive, memory stick, or other computer-readable medium for storing and transmitting data; an internet or other remotely located network or data source; etc. As another option or alternative, external source 122 may be connected to the computing system 106 via a wireless connection (represented at reference number 124), which may be operatively coupled to an appropriate wireless transmission/reception interface 110 provided with or operatively coupled to the system 106. The various components of the overall system illustrated in FIG. 1 may be included within a single housing or component or may be provided as any desired number of separate components and/or at any desired number of locations without departing from this invention.

Various more specific examples of use of and information input to and/or output from the system 100 and its various component parts will be described in more detail below.

### B. General Description of Golf Club Fitting Systems and Methods According to Examples of the Invention

In general, as described above, aspects of this invention relate to systems and methods for fitting a golfer with a fitted set of golf clubs (e.g., a set of two or more clubs). One such method for fitting a golfer with plural golf clubs includes: (a) fitting a golfer with a driver based, at least in part, on launch monitor data generated during one or more golf club hitting sessions in which the golfer hits drivers having different combinations of loft angle and/or shaft flexibility characteristics, wherein the driver to which the golfer is fitted includes a first loft angle and a first shaft flexibility characteristic; (b) selecting plural initial candidate fairway wood clubs based, at least in part, on the first loft angle and the first shaft flexibility characteristic; (c) hitting golf balls using the plural initial candidate fairway wood clubs and collecting launch monitor data relating to the hits correlated to the initial fairway wood club used for the hit; (d) optionally, selecting one or more additional candidate fairway wood clubs based, at least in part, on the launch monitor data collected when the initial fairway wood clubs were hit, and hitting golf balls using the one or more additional candidate fairway wood clubs; and (e) providing a recommendation for a final first fairway wood club based, at least in part, on the launch monitor data collected when one or more of the initial or additional candidate fairway wood clubs were hit. The selection and recommendation steps may be performed, in whole or in part, using a computer system.

Computer-implemented systems and methods in accordance with examples of this invention may include: (a) receiving input data (e.g., via any desired computer input hardware) indicating a golfer's driver loft angle and at least one driver shaft flexibility characteristic; (b) determining plural initial candidate fairway wood clubs based, at least in part, on the driver loft angle and the driver shaft flexibility characteristic (e.g., utilizing a computer processing system); and (c) outputting data identifying the selected plural initial candidate fairway wood clubs (e.g., via any desired computer operated output hardware). Such systems and methods further may include one or more of the following steps: (d) receiving launch monitor data generated when the golfer hits golf balls using the plural initial candidate fairway wood clubs, wherein the launch monitor data is correlated to the initial candidate fairway wood club used for the hit; (e) determining one or more additional candidate fairway wood clubs for testing based, at least in part, on the launch monitor data received based on the initial candidate fairway wood clubs hits; (f) outputting data identifying the additional candidate fairway wood clubs; (g) receiving launch monitor data generated when the golfer hits golf balls using the one or more additional candidate fairway wood clubs, wherein the launch monitor data is correlated to the additional candidate fairway wood club used for the hit; (h) determining a recommendation for a final first fairway wood club based, at least in part, on the launch monitor data received based on one or more of the initial or additional candidate fairway wood clubs hits; and (i) outputting data identifying the recommendation for the final first fairway wood club.

The recommendation for the final first fairway wood club to be included in the fitted club set may be based on any desired information. In accordance with at least some examples of this invention, this recommendation will be based, at least in part, on an average ball carry distance included in the launch monitor data received after one or more of the initial or additional candidate fairway wood clubs were hit, such as the initial or additional candidate fairway wood club that generated a highest average ball carry distance and/or highest average total distance during launch monitor testing.

Aspects of this invention may include fitting steps to fit additional clubs, such as irons, hybrids, and/or additional fairway woods. Accordingly, at least some example systems and methods according to this invention may include: (a) receiving launch monitor data relating to golf ball hits using one or more irons; (b) receiving launch monitor data relating to golf ball hits using a one or more hybrid clubs and/or fairway woods; (c) determining a desired carry distance or a desired carry distance range for clubs in a fitted set based, at least in part, on an average ball carry distance and/or average total distance for at least one of the driver or a first fairway wood club (e.g., optionally, the previously fit clubs described above); (d) determining whether an average ball carry distance of one or more of the irons or the hybrid clubs better matches the desired carry distance or the desired carry distance range for the fitted set; (e) determining a recommendation for inclusion of one or more irons or hybrid clubs in the fitted set; and (f) outputting data indicating the recommendations. In this manner, the fitter can attempt to fit the golfer with clubs having a regular, stepped carry distance as the golfer uses different clubs in his or her bag. Part of the iron, hybrid, and/or fairway wood fitting systems and methods may include determination and customization of proper shaft length and/or lie angles (and/or other features) for the clubs in the fitted set.

Additional aspects of this invention relate to computer-readable media including computer-executable instructions stored thereon for performing the various methods and/or operating the various systems described above (and those described in more detail below). Such computer-readable media may include, but are not necessarily limited to: computer-readable memories, both internal to a computer (e.g., hard drives) or separable from the computer (such as disks, solid state or flash memory devices, etc.).

Still additional aspects of this invention relate to the computer-generated displays and/or graphical user interfaces used to present information to and/or receive input data from the club fitter, the golfer, or other user. As one more specific example, video displays or graphical user interfaces (and computer-readable media for generating such displays or interfaces) in accordance with some examples of this invention may include: (a) a two-dimensional graphic representation having golf ball launch angle information provided on a first coordinate axis and golf ball spin rate information provided on a second coordinate axis; (b) an indication on the two-dimensional graphic representation of a target zone of combined launch angles and spin rates for a predetermined ball launch speed and/or club head speed parameter; and (c) one or more indicators identifying a ball launch angle and a ball spin rate on the two-dimensional graphic representation for one or more golf ball hits, wherein one indicator is provided for each respective golf ball hit shown on the graphic representation. If desired, the one or more indicators further may identify a golf club used in the golf ball hit represented by the respective indicators or the video display may otherwise identify a golf club used in making one or more of the golf ball hits indicated on the video display. Also, if desired, the graphical user interface may allow a user to indicate one (or more) of the golf ball hits for which an indicator is provided and for which more data is desired. This input may result in the display of additional data relating to the golf shot on the video display, such as ball speed data, club head speed data, launch angle data, total ball spin data, ball side spin data, ball side spin direction data, ball carry distance data, and/or total ball flight distance data. Such video displays or interfaces may help illustrate to the user how a golfer's individual shots measure up with respect to a target (e.g., optimum) launch angle and/or spin rate for a given ball or club head speed (or for a given club).

As another example, video displays and/or user interfaces in accordance with at least some examples of this invention may assist a user in identifying the proper progression of clubs in a golfer's bag (e.g., so that each club's average carry or total travel distance will change in a relatively regular or constant manner as the golfer uses different clubs in his or her bag). In other words, a golfer may wish to have his five iron travel, on average, 10 yards further than the six iron, and the six iron, travel (on average) 10 yards farther than the seven iron, etc. In this manner, the golfer will not have any significant distance gaps in his or her bag. Such video displays or user interfaces may include: (a) a two-dimensional graphic representation having golf ball carry distance information or golf ball total travel distance information provided on a first coordinate axis and golf club identifier information provided on a second coordinate axis; (b) an indicator on the two-dimensional graphic representation of a golf ball carry distance or golf ball total travel distance for at least one of a driver or a first fairway wood golf club; (c) a first sloped line indicating a first change in carry distance or total travel distance yardage, wherein the first sloped line originates from the indicator for the driver or the first fairway wood golf club; and (d) one or more point indicators representing a golf ball carry distance or golf ball total travel distance for at least one additional fairway wood, hybrid club, or iron club. If desired, the video display may include two or more sloped lines, e.g., each line indicating a different constant change in carry distance or total travel distance yardage. Additionally, or alternatively, the video display further may include one or more lines indicating golf ball carry distances or golf ball total travel distances for one or more additional club (such as hybrid clubs or fairway woods). These lines allow the user to easily see where, if anywhere, these one or more additional clubs would best fit in the golfer's bag (e.g., whether a certain hybrid club or fairway wood would better replace a three iron or a four iron, etc., so as to avoid a significant distance gap between clubs in the bag).

Additional aspects of this invention relate to computer-generated displays and/or graphical user interfaces used to present information to and/or receive input data from the club fitter, the golfer, or other users in the operation of the various systems and in the performance of the various methods described above. Examples of such displays and user interfaces will be described in more detail below.

Specific examples of the invention are described in more detail below. The reader should understand that these specific examples are set forth merely to illustrate examples of the invention, and they should not be construed as limiting the invention.

### C. Specific Examples of the Invention

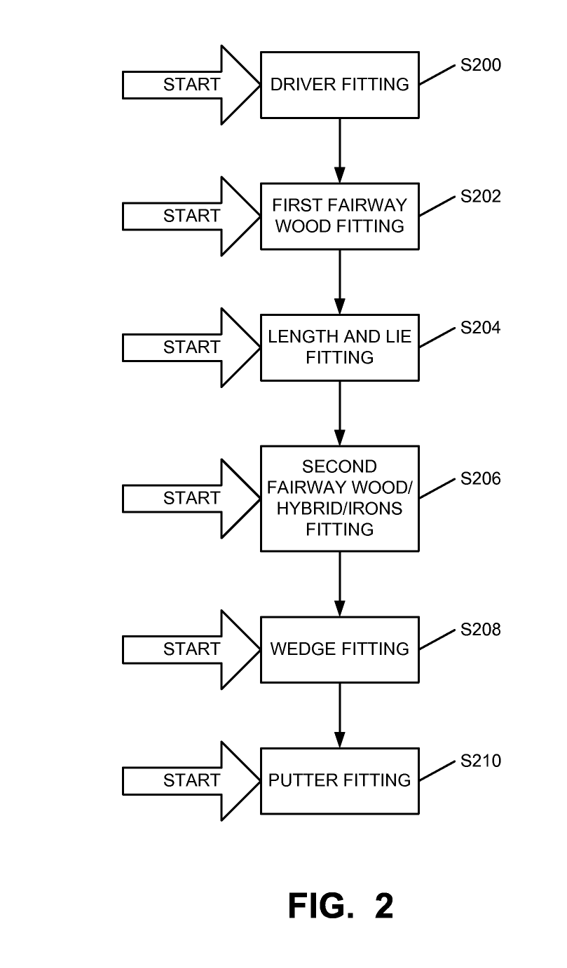

As described above, FIG. 1 generally illustrates a launch monitor system 100 that may be used in conjunction with various aspects of this invention. FIG. 2 generally illustrates example components and/or steps of an overall fitting system and method in accordance with this invention. In one example of the invention, a club fitting session will fit a user with an entire set of golf clubs (or substantially an entire set of golf clubs), e.g. in a manner so that the user maintains a relatively constant distance differential among the clubs within the fitted set. In the specific example fitting system and method described in conjunction with FIG. 2, first the user will be fit with a driver (S200). Then, based at least in part on the information obtained and used for the driver fitting (as will be explained in more detail below), the user will be fit with a first fairway wood club (S202). Next, input data and information will be received to allow for a club length and/or lie fitting (S204), and this information (and/or other information) will be used to make a second fairway wood/hybrid/iron club fitting (S206). Systems and methods according to this invention further may include a wedge fitting component or procedure (S208) and/or a putter fitting component or procedure (S210).

Of course, many variations in the system and method described in conjunction with FIG. 2 are possible without departing from this invention. For example, the various steps or components may be changed, changed in order, and the like without departing from this invention. Additionally, one or more of the steps may be omitted and/or the user may start at any desired step and/or complete the steps (or a portion thereof) in any desired order without departing from this invention. In at least some examples of systems and methods according to the invention, data and information collected at one of the fitting steps may be used and built upon in one or more of the later fitting steps, e.g., for fitting other clubs in the fitted bag. Examples of features of the various steps and components are described in more detail below.

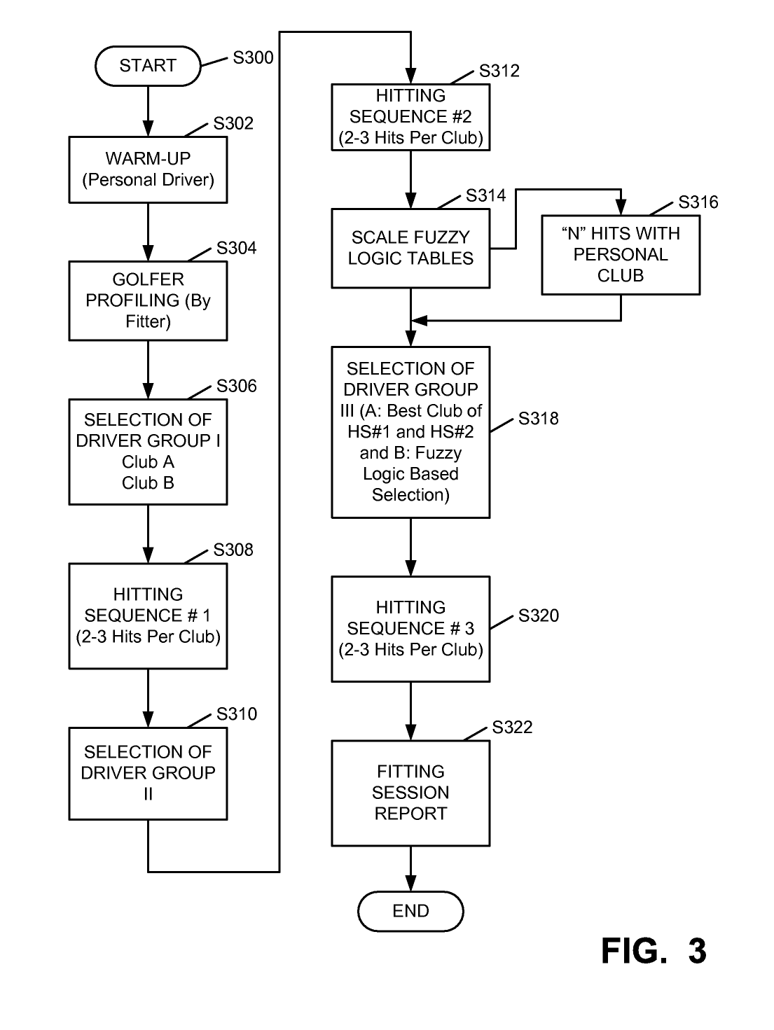

FIG. 3 illustrates an example of features of a driver fitting system and/or method according to an example of this invention. At the start (S300) of this system and method, the user warms up (S302), optionally by hitting balls using their existing personal driver and/or other club(s). Although one need not do so, if desired, these warm-up shots may be monitored by a launch monitor or otherwise observed by the club fitter. For example, during these warm-up shots (or through a questioning period), the system and/or the club fitter may ascertain some basic information about the user's natural swing characteristics or tendencies, e.g., swing “profile” information (S304), such as if the golfer tends to be a slicer, a hooker, an excessively “over-the-top” swinger, an excessively “inside-to-outside” swinger, a “caster,” typical ball spin information, typical ball launch angle information, typical swing speed information, typical ball flight information, etc.

Based on the initially obtained profile or other information, systems and methods according to examples of this invention may select an initial driver group for further testing (S306). While this initial driver group may include any desired number of clubs, in this illustrated example, two different clubs will be selected for initial testing in Driver Group I. As a more specific example, based on the profile information collected at S304, systems and methods according to examples of this invention may select two initial driver clubs for testing that have various suggested characteristics and combination of characteristics, such as shaft material, shaft flex, and/or shaft kick point location (e.g., extra stiff, stiff, regular, senior, ladies, etc., based on club head speed, etc.); club loft angle (e.g., 6.5° to 16°, based on ball launch angle, club head speed, etc.); club head weighting (e.g. heel concentrated weighting, toe concentrated weighting, neutral weighting etc., based on typical ball flight or swing characteristics, etc.); shaft length (e.g., based on player height, set-up, swing type, etc.); grip diameter, grip material, or the like (e.g., based on user hand size, swing type, personal preferences, etc.), etc.

Once the initial driver group for testing is ascertained, the user will then hit balls with the suggested clubs from this grouping (S308). While any number of hits may be made with each club, in systems and methods in accordance with at least some examples of this invention, the user may hit 2-3 shots with each suggested club included in the initial driver group. These shots will be monitored by a launch monitor, e.g., of the type illustrated in FIG. 1, to collect relevant shot data for selecting and fitting a final driver product, such as ball launch angle, ball spin rate, ball spin direction, ball flight deviation from center or straight, ball speed, club head speed, etc.

As a result of the data collected from the shots made using the first driver grouping, if desired, a second driver grouping may be selected (e.g. including one or more additional clubs) for additional testing (S310). For example, given the general club head speed or ball launch velocity speed for a given user as measured using the first driver grouping, systems and methods according to examples of this invention may suggest additional club constructions or component parts for further testing, in an effort to optimize the ball launch angle and/or ball spin conditions for the user's swing. For example, the launch monitor data from testing the initial driver group may indicate that a different club head loft angle might be useful to produce a more optimum initial ball flight launch angle, so the systems and methods according to the invention may suggest club heads having different loft angles in an effort to optimize this variable. As another example, the launch monitor data from testing the initial driver group may indicate that a different shaft stiffness or kickpoint location may be useful to optimize club head speed and/or to alter the spin rate of the ball's initial launch. In this example, systems and methods according to the invention may suggest different shafts having different characteristics in an effort to optimize this variable. Suggestions for clubs and/or club components having other features and combinations of features (such as weight distribution, etc.) further may be provided in an effort to optimize any desired parameter, such as initial ball velocity, launch angle, spin speed, spin direction, carry, total distance, etc.

Once the second driver group is selected, the user may hit balls with the drivers from this grouping (S312), optionally hitting each club 2-3 times. Given the resultant data, the club fitter may consider adding another club for testing, e.g., using “fuzzy logic” (S314) such as the fitter's review of the data, the fitter's personal observations of the golfer and/or his/her swing, the fitter's intuition as to how a change in a club head characteristic (such as loft angle, shaft flex, kick point, weight distribution, etc.) may affect the measured ball flight characteristics (such as launch angle, spin rate, spin direction, etc.); etc. Optionally (or additionally), the user or fitter may elect to have the user make some swings (e.g. 2-3 swings) using the user's present driver (S316), and launch monitor data from these swings may be collected.

A final third set of clubs then may be selected for testing (S318). In some examples of this invention, this third set of clubs may include one or more of the following: (a) the club combination from the initial driver grouping (Hitting Sequence 1) that produced the best results, (b) the club combination from the second driver grouping (Hitting Sequence 2) that produced the best results, (c) the “fuzzy logic” based selection from S314 (after Hitting Sequence 2), and/or (d) the user's personal club. One or more of these clubs are then hit by the user in Hitting Sequence 3 (e.g., 2-3 hits per club, S320), and a fitting session report is generated S322 (examples of which will be discussed in more detail below). The fitting session report may include a recommendation for a final club construction (e.g., club head loft, shaft material, shaft stiffness, shaft kick-point, club head weight distribution, grip size, etc.), based on those tested, e.g. the club construction from Hitting Sequence 3 (or one of the other Hitting Sequences) that produced the most favorable or consistent results (e.g., the straightest ball flight, the longest ball carry, the longest total distance, the most consistent results, etc.). The entire driver fitting session may contain a relatively small number of golf shots, such as approximately 20.

Advantageously, systems and methods in accordance with this invention may be practiced using clubs having a releasable club head/shaft connection (e.g., clubs constructed with removable shaft/head connections so that different heads can be quickly secured to a given shaft and/or so that different shafts can be quickly secured to a given head construction). Examples of such releasable club head/shaft connections are known in the art through various golf manufacturers, such as NIKE Golf, Callaway Golf, and/or Taylor Made Golf Additional examples of such systems are provided in U.S. Pat. No. 6,890,269 to Burrows; U.S. patent application Ser. No. 11/612,072 to Burrows; U.S. patent application Ser. No. 11/774,513 to Thomas, et al.; U.S. patent application Ser. No. 11/774,519 to Thomas, et al.; U.S. patent application Ser. No. 11/774,522 to Stites, et al.; and U.S. patent application Ser. No. 11/846,370 to Stites, et al. These documents are entirely incorporated herein by reference. If desired, grip elements may be releasably connected to shafts in the same or similar manner as the releasable head/shaft connections described above.

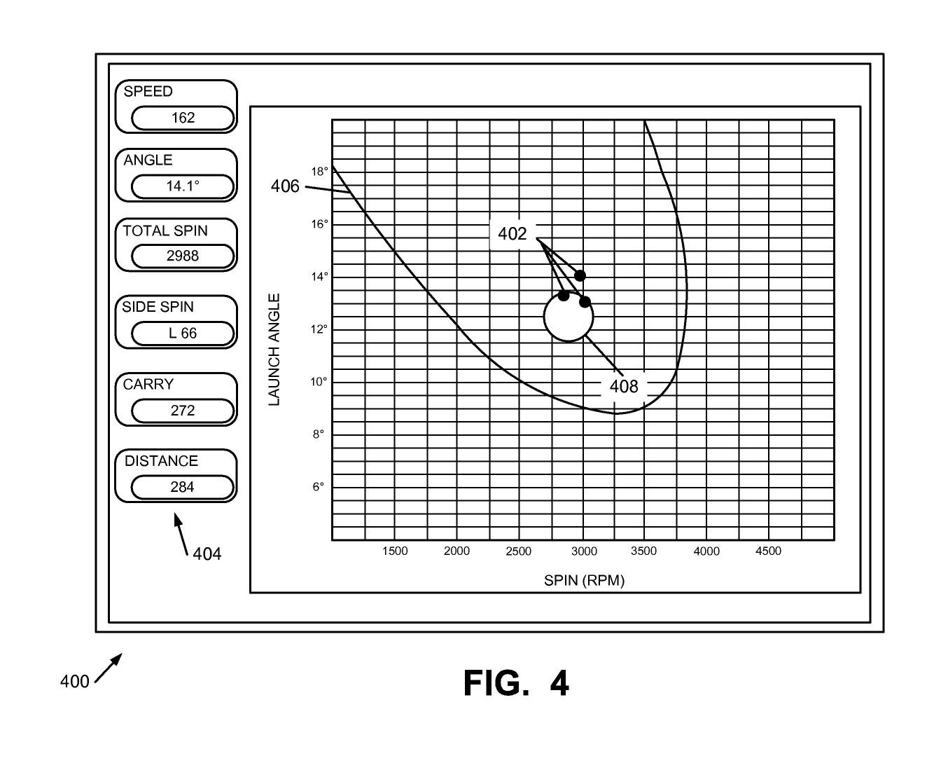

FIG. 4 illustrates an example display 400 for launch monitor generated data that may be used in accordance with at least some examples of this invention. This display 400 includes a plot of ball launch angle data on one axis and ball spin rate on the other axis, and the user's individual shots are plotted on the graph at their respective locations (see elements 402). This display 400 further includes a shot data zone 404 that includes data relating to an individual shot (e.g., data relating to one of the shots represented by elements 402). While any desired data may be provided on the display 400 and/or within zone 404 without departing from this invention, in this illustrated example, the data zone 404 includes ball launch speed data, ball launch angle data, total spin data, side spin data, projected ball carry distance data, and projected overall ball travel distance data. While illustrated in FIG. 4 as a computer-generated display 400, other display forms or formats are possible without departing from this invention, including, for example, paper printouts, displays on cellular telephones or other small electronic devices, etc.

Additional information may be provided in the display 400 without departing from this invention. For example, for a given club head speed and/or initial ball velocity, there are generally more desirable launch angle and spin rate characteristics or ranges that will provide an improved ball flight (e.g., longer carry, longer overall travel distance, etc.), and even zones of launch angle and spin rate characteristics or ranges that will provide optimum results. These desirable ranges and/or optimum zones may be provided or shown on the display 400, if desired, in accordance with at least some examples of this invention. These features are illustrated in the example display 400 of FIG. 4 by the line 406 (which illustrates and encloses generally broad and desirable ranges of launch angle and spin rate characteristics) and zone 408 (which illustrates an optimum launch angle and spin rate combination for a specific initial ball speed). Different ball speeds may result in different plots for line 406 and/or different locations for zone 408. Notably, in this example, the user's shots (represented by elements 402) lie within or close to the optimum zone 408. This display 400 can help better assist users in determining the club and/or individual shots that provided the best results.

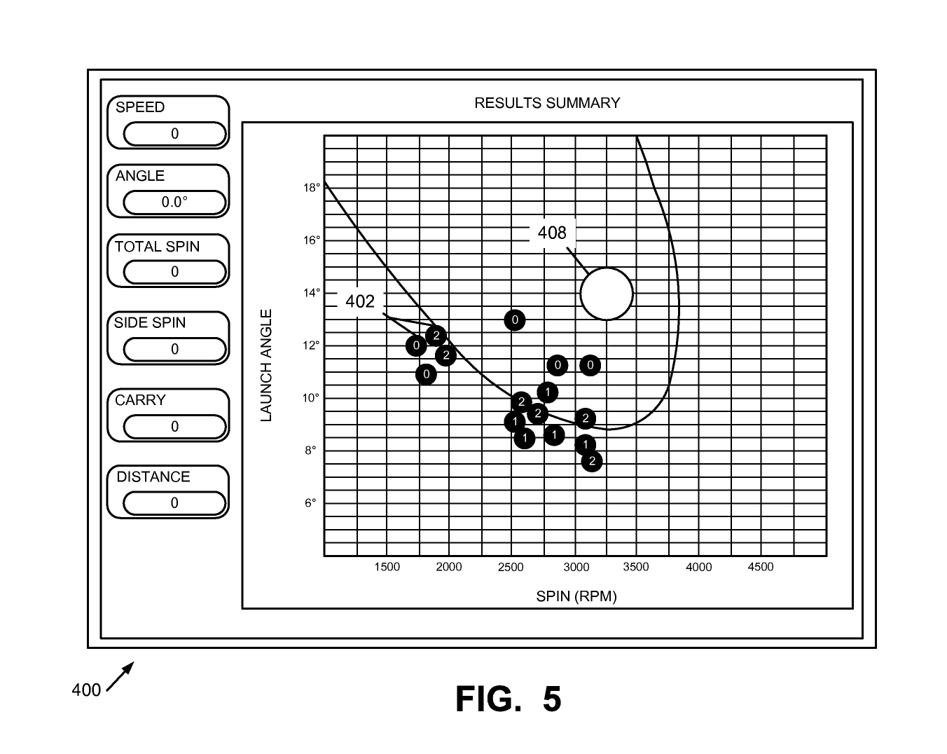

FIG. 5 further illustrates how the display 400 can be useful in selecting the club head, shaft, and/or other combination of characteristics that provide the best results. FIG. 5 illustrates the display 400 of FIG. 4 with the results of hits from several clubs provided thereon (the hits for the different clubs are evidenced by the different numbers within elements 402). The combined data allow the user or fitter to easily see the club(s) that tended to provide the best results. Moreover, from these plotted results, an experienced club fitter may be able to suggest certain club head characteristic changes (e.g., loft angle, shaft flex, etc.) or ball characteristic changes that might move the user's results closer to the optimum range 408.

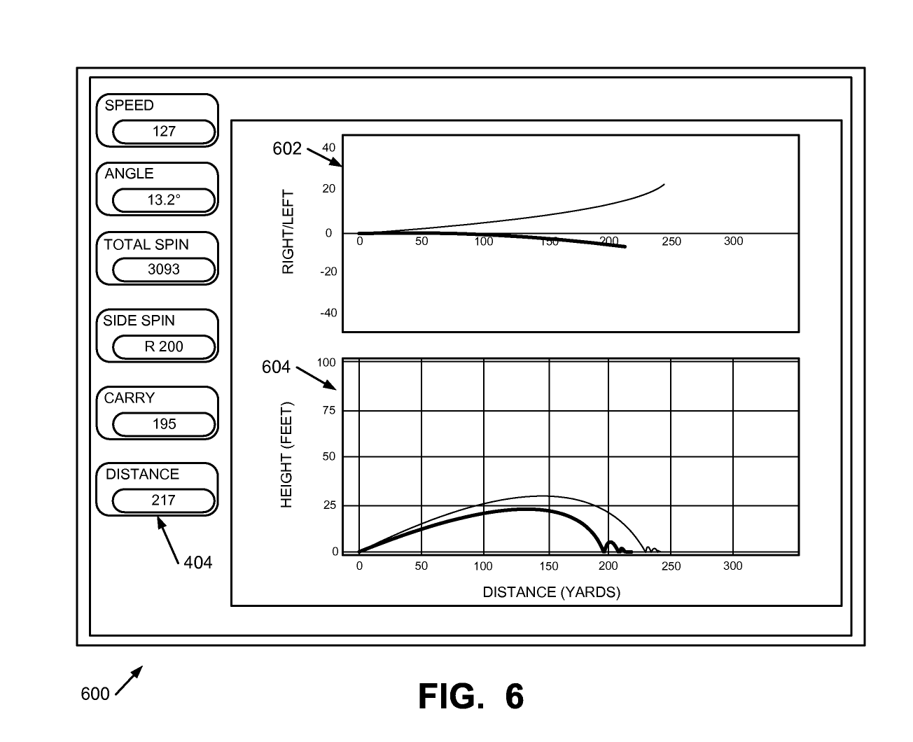

Systems and methods in accordance with examples of this invention may provide and/or display additional information, if desired. FIG. 6 illustrates a display 600 (e.g., computer display, printout, etc.) that illustrates the projected ball flight as measured and projected from the launch monitor data. For example, in this illustrated display 600 a top chart or graph 602 is provided to illustrate the projected ball flight for one or more shots (as measured by the launch monitor) and the shot's deviation from a straight line flight (or from a center line), in order to illustrate potential hook, slice, fade, draw, or other ball flight characteristics. Additionally, this illustrated display 600 provides a second chart or graph 604 to illustrate the projected ball flight trajectory for one or more shots (as measured by the launch monitor), as well as the shot's projected carry and roll distances. The shot data zone 404 provides more detailed data for one of the illustrated shots, namely the bolded or highlighted shot from charts 602 and 604 in the illustrated example. Of course, any number of individual shots (using any desired number of clubs) may be shown in the display 600 and/or other data content and/or arrangements of the data may be provided without departing from this invention. If desired, the display 600 may indicate the club used for the various shots, e.g. using different color lines, different line forms, etc.

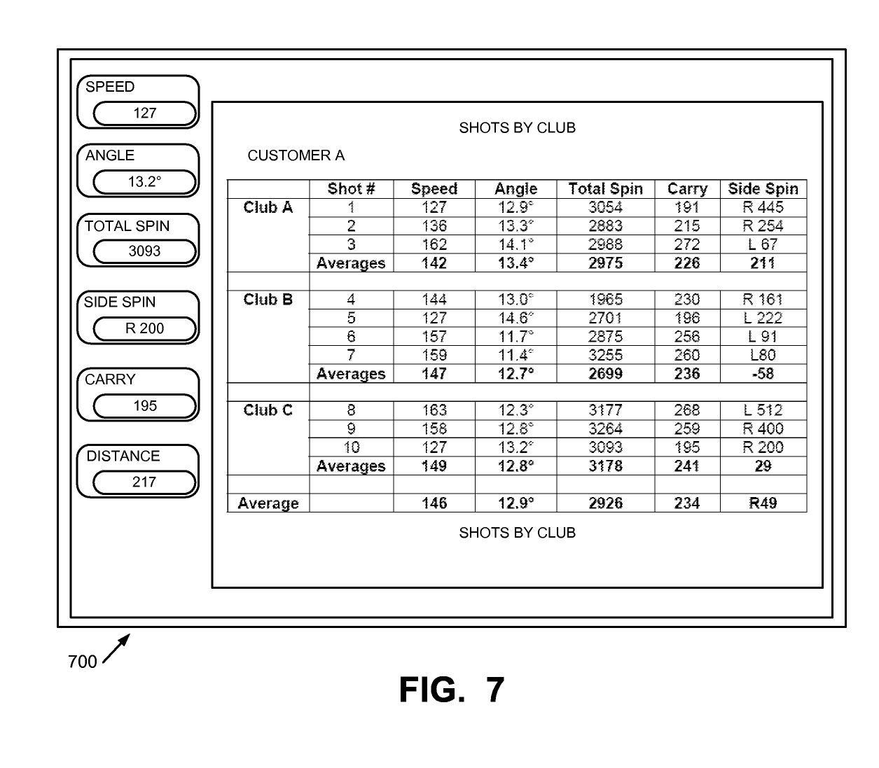

Systems and methods in accordance with examples of this invention can provide information in other forms and formats without departing from the invention. For example, FIG. 7 illustrates an example display 700 (e.g., computer display, printout, etc.) in which information and data for several different clubs is provided in a chart form. The display 700 of FIG. 7 or other desired display (such as those of the types illustrated in FIGS. 4-6) may be provided to the user as at least part of the Fitting Session Report (optionally along with a recommendation for a fitted driver or final driver construction (e.g., including recommendations for one or more club head loft, shaft material, shaft stiffness, shaft kick-point, club head weight distribution, grip size, etc.)).

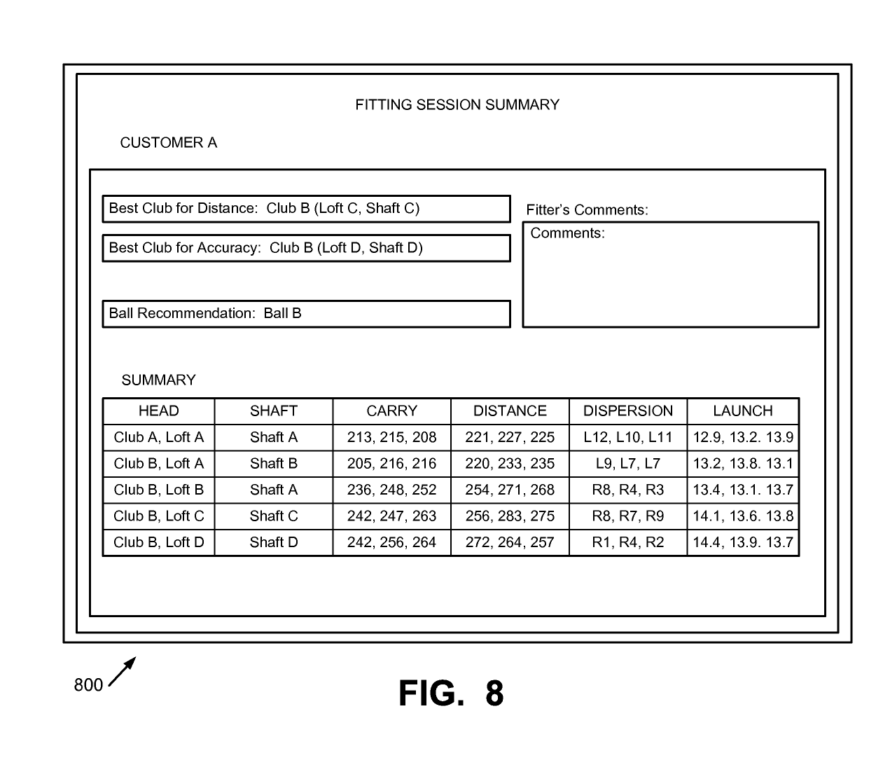

FIG. 8 illustrates another display 800 (e.g., computer display, printout, etc.) of a Fitting Session Summary that may be provided in accordance with at least some examples of this invention. In this example display 800, a recommendation or the system's determination of the user's best club for distance and the best club for accuracy are provided, as well as a ball recommendation (e.g. a ball that will provide the best spin characteristics for the golfer). This example fitting session included tests with club constructions having combinations of three different variables, namely: club type (e.g., a specific brand or clubs from a specific manufacturer), club head loft angle, and shaft, and the recommendations are provided based on the measured launch data, as described above (e.g., the club type, loft angle, and shaft combination providing the overall greatest distance, best accuracy, etc.).

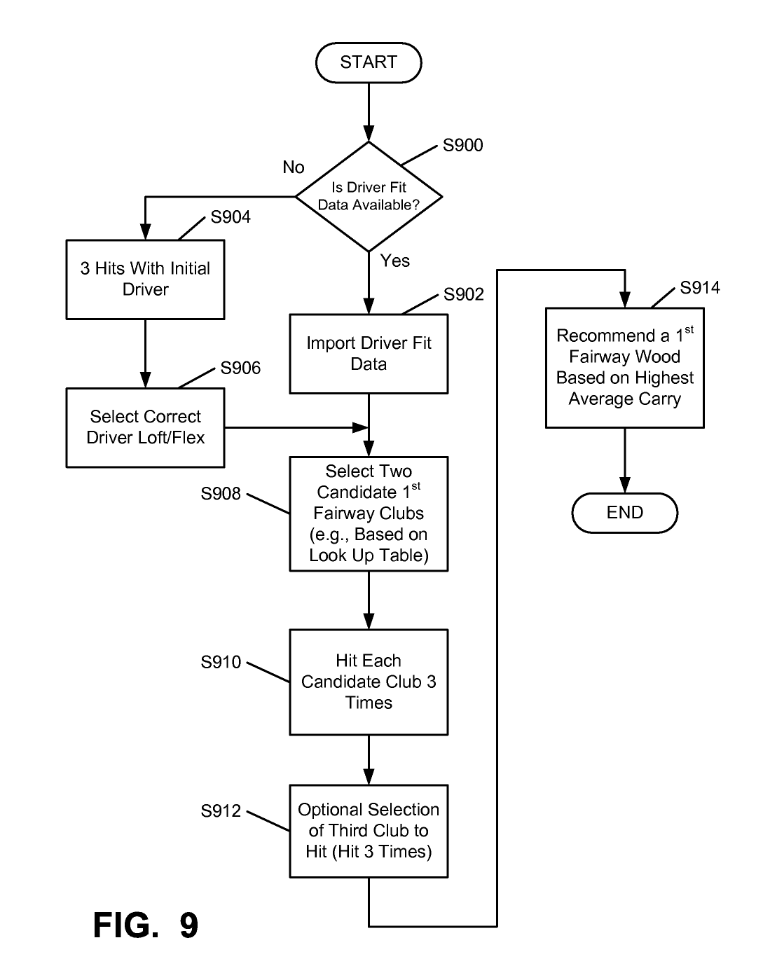

As noted above, systems and methods according to at least some examples of this invention may be used to fit users with additional clubs, if desired. For example, after the driver fitting session has completed, systems and methods in accordance with at least some examples of this invention may lead users and club fitters down a path that will begin fitting for the next desired club in the set. FIG. 9 illustrates an example system and method in which a first fairway wood club is fit to the user. As this portion of the fitting procedure starts, a determination first is made as to whether the user was just fit with a driver, e.g., using the process described above (S900). If yes, this fitted driver data may be used in the first fairway wood club fitting process as will be described in more detail below (S902). If no, the user may be asked to make some hits (e.g. three hits) with his/her personal driver or some standard driver (S904) in order to give the fitter and/or launch monitor system an opportunity to observe the user's swing and to make some initial recommendations (S906) as to various driver characteristics for this user, such as desirable driver loft and shaft flex for this particular user. Alternatively, rather than hitting his/her personal driver, the information relating to that personal driver may just be input into the system and used as a starting point for selecting the driver loft and shaft flex in S906.

Once the user's driver characteristics are determined (e.g., imported from the driver fitting session, from the user's existing driver, from the fitter's or system's determination after monitoring the user hitting the driver, etc.), two candidate first fairway wood clubs are selected for initial testing (S908). Any desired manner of selecting two candidate first fairway wood clubs based on the driver data may be used without departing from this invention. In systems and methods in accordance with some examples of this invention, the first candidate fairway wood clubs may be selected based on “look-up tables” provided and programmed in to the system. For example, two tables may be provided, one for each of the two candidate first fairway wood clubs to be initially selected. Based on the fitted or other driver data, these two look-up tables provide the two initial recommendations as to specific first fairway wood club characteristics. One recommendation tends to accent or be more directed to the priority that the user will use this first fairway wood off the tee for tee shots. The other recommendation tends to accent or be more directed to the priority that the user will use this first fairway wood in the fairway or rough, trying to maximize fairway carry. Examples of these initial first fairway wood “recommendation look-up tables” are provided below:

TABLE 1A
PRIORITY = TEE SHOTS

| Driver | Driver Flex | | | | |
|---|---|---|---|---|---|
| Loft | W | A | R | S | X |
| 8.5 | | | | 13 | 13 |
| 9.5 | | | | 13 | 13 |
| 10.5 | 17 | 15 | 15 | 15 | 15 |
| 11.5 | 17 | 17 | 15 | 15 | 15 |
| 13 | 17 | 17 | 17 | 17 | |
| 16 | 19 | 19 | 19 | 19 | |

TABLE 1B
PRIORITY = FAIRWAY CARRY

| Driver | Driver Flex | | | | |
|---|---|---|---|---|---|
| Loft | W | A | R | S | X |
| 8.5 | | | | 15 | 15 |
| 9.5 | | | | 15 | 15 |
| 10.5 | 19 | 17 | 17 | 17 | 17 |
| 11.5 | 19 | 19 | 17 | 17 | 17 |
| 13 | 19 | 19 | 19 | 19 | |
| 16 | 21 | 21 | 21 | 21 | |

Accordingly, using these tables, a user fitted for a 10.5 degree driver having a regular (“R”) shaft flex would be provided two recommendations for the first fairway wood club in S908, namely, a 15 degree first fairway wood having the same shaft flex as the driver (from Table 1A) and a 17 degree first fairway wood having the same shaft flex as the driver (from Table 1B). Once selected, each candidate first fairway wood club is hit (S910), optionally using the launch monitor to determine various characteristics of the ball strike, such as launch angle, spin rate, launch ball speed, club head speed, projected ball carry distance, projected total carry distance, etc. While any number of hits is possible, in some examples of this invention, about three hits with each club will typically be adequate.

If desired, at S912, the system, fitter, or user may select a third (or more) first fairway wood clubs to hit (e.g., clubs of a different brand or manufacturer, clubs having different lofts, clubs with different shaft characteristics, clubs with different weight distributions, etc.). Once the user or fitter has hit all of the desired clubs, a final first fairway wood club may be recommended based on the hitting results (S914). While any desired data may control or be used in making the recommendation, if desired, the recommendation may be based on the club construction that provided the longest average carry, the longest average total distance, the minimal left/right dispersion, the optimum spin rates, etc. In some examples of this invention, this recommendation may be made solely or predominantly based on the hit club that provided the highest average ball carry distance (e.g., as projected from the launch monitor data).

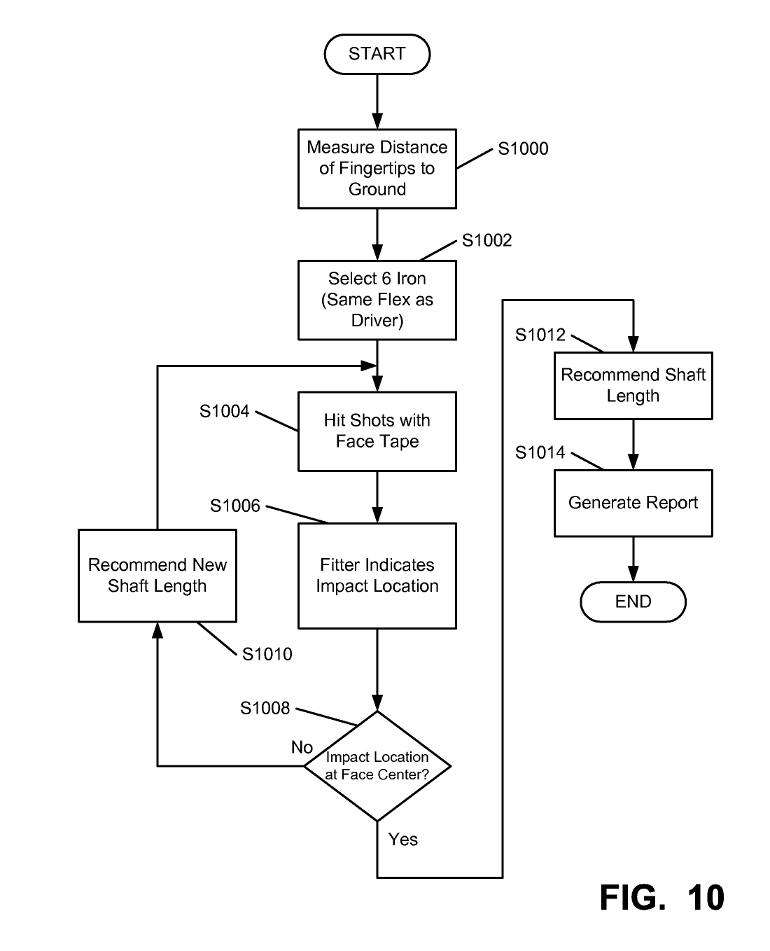

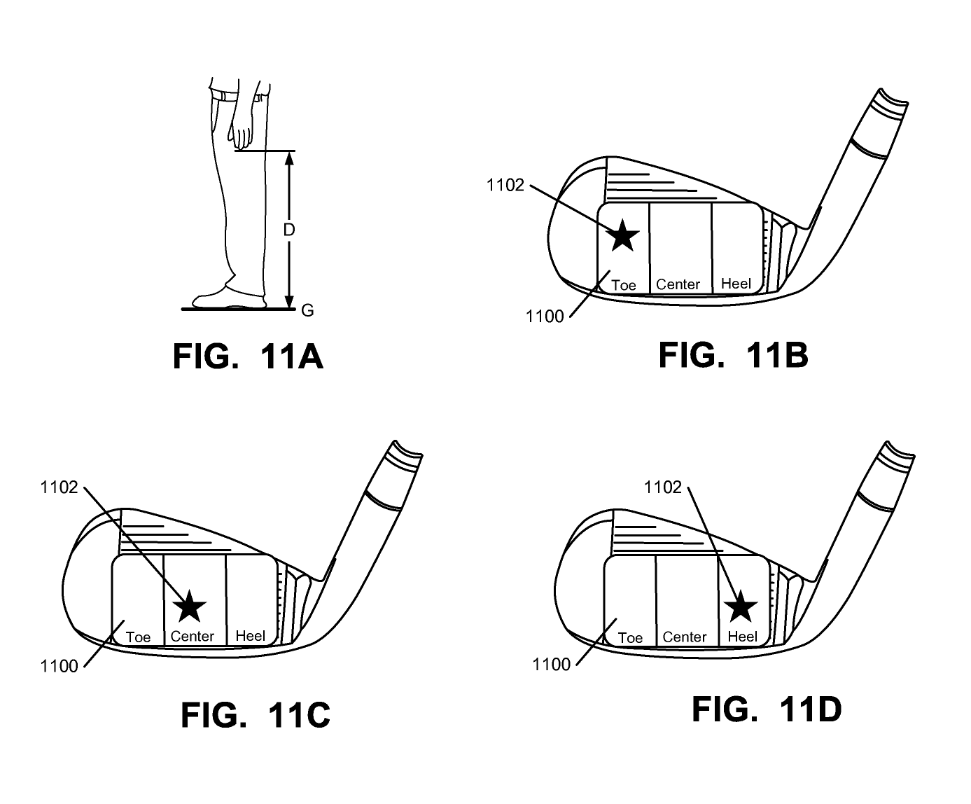

As a next (or another) step in the overall fitting process, club length and/or lie fitting steps may be performed. FIG. 10 illustrates an example club head length fitting or determination procedure that may be used in accordance with at least some examples of this invention, and FIGS. 11A through 11D illustrate various features of the procedure. As an initial step in this process, the fitter measures the distance D from the golfer's fingertips to the ground G (S1000, distance D in FIG. 11A). Using this measured distance, an initial shaft length is selected, e.g., using the information provided in the following Table (this information may be programmed into systems and methods in accordance with this invention, e.g., as a “look-up” table):

TABLE
STARTING POINT FOR SHAFT LENGTH

| | Distance D (Inches) | Shaft Length to Start |
|---|---|---|
| Women | <22 | ½ Inch Less Than Women's Standard |
| | 22-25 | Women's Standard |
| | 25-28 | ½ Inch Greater Than Women's Standard |
| | >28 | 1 Inch Greater Than Women's Standard |
| Men | <25.5 | ½ Inch Less Than Men's Standard |
| | 25.5-28 | Men's Standard |
| | 28-30 | ½ Inch Greater Than Men's Standard |
| | >30 | 1 Inch Greater Than Men's Standard |

Using the determined starting point for the shaft length, the user selects a 6-iron club (S1002) having the determined shaft length from the Table above and having the same flex characteristics as the previously determined driver for the golfer (e.g., regular, stiff, ladies, senior, extra-stiff, etc.). Using impact tape on the face of the golf club (or other impact location point determining means, including an electronic club head having an impact location point determining system incorporated therein), the user then hits some shots with the club head (S1004). For each shot, the fitter notes the impact location (S1006). For example, as illustrated in FIG. 11B, for a toe hit, the impact tape 1100 will change to include a mark 1102 at the toe to indicate that the golf ball hit in the toe area of the club at that specific hit. Similarly, as illustrated in FIG. 11C, for a center hit, the impact tape 1100 will change to include a mark 1102 at the center to indicate that the golf ball hit in the central portion of the club at that specific hit, and as illustrated in FIG. 11D, for a heel hit, the impact tape 1100 will change to include a mark 1102 at the heel to indicate that the golf ball hit in the heel portion of the club at that specific hit. If desired, the fitter may simply take notice of the various impact locations. Alternatively, if desired, systems and methods according to the invention may provide a user interface that allows the user or the fitter to enter data into the system indicating the various impact locations (e.g. by providing an interface on a computer display allowing the user or the fitter to “click on” a representation of club head face at the location of the impact). As yet another example, if an electronic club is used having a face impact location determining means, the impact location may be automatically transferred to systems and methods in accordance with this invention.

Once the face impact location for one or more shots is determined, a determination is made (by the fitter, by the system based on the input data, etc.) as to whether the impact is at the face center (S1008). If no, a new shaft length may be recommended (S1010), and this process can return to S1004, where balls are again hit and the impact location is determined.

Although any adjustment in the shaft length at S1010 based on the face impact location may be provided without departing from this invention, the following table or information may be used as a basis for determining the new shaft length recommendation at S1010:

Shaft Length Changes Based on Face Tape
Mark (or Other Impact Location Indicator)

| Toe Hit | Center Hit | Heel Hit |
|---|---|---|
| +½ Inch | 0 | −½ Inch |

Optionally, additional length may be added to or eliminated from the new recommended shaft length (e.g., ±¾ inches), if desired, for extreme toe or heel hits. Additionally or alternatively, less length may be added to or eliminated from the new recommended shaft length (e.g. ±¼ inches), if desired, for heel and/or toe hits that are relatively close to the central zone.

The process S1004-S1010 may be repeated, as necessary, until consistent central impact locations are observed or measured (answer “yes” at S1008). Then, this shaft length (or adjustment from a standard shaft length) may be provided as a shaft length recommendation at S1012 (e.g., for the irons, the recommendation may indicate that each shaft should be increased or decreased a fixed amount from a standard shaft length for that iron). If desired, a report may be generated (S1014) (e.g., as a printed copy, a computer display, etc.) indicating the recommended shaft length or shaft length adjustment from standard.

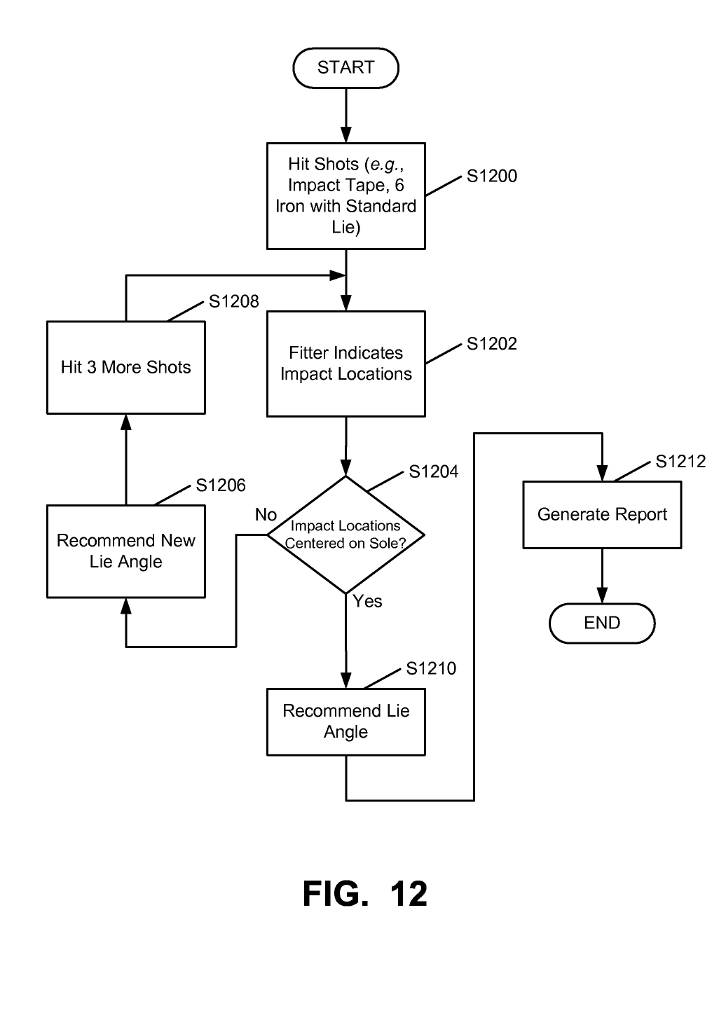

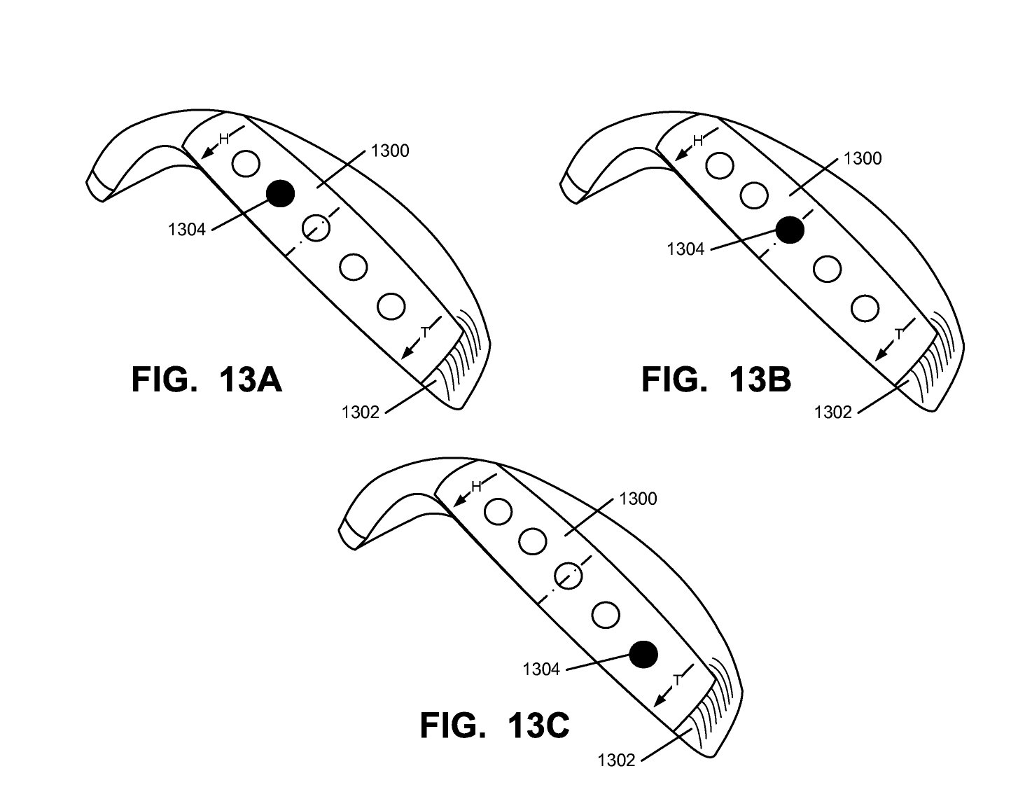

FIG. 12 illustrates an example lie angle determination procedure that may be used in systems and methods in accordance with this invention, and FIGS. 13A through 13C help explain this procedure. In this instance, impact tape 1300 is applied to the club head sole 1302 (e.g., a 6-iron with a standard lie angle, optionally using a shaft length adjusted in the manner determined above in conjunction with FIGS. 10 and 11) so that the club head's impact location with the ground (e.g., a “lie board”) may be determined. Alternatively, rather than impact tape, other impact location point determining means may be provided, including an electronic club head having an impact location point determining system incorporated therein. Using the impact tape 1300 on the sole 1302 of the golf club (or other impact location point determining means), the user then hits some shots with the club head (S1200). For each shot, the fitter notes the impact location (S1202). For example, as illustrated in FIG. 13A, for a heel hit, the impact tape 1300 will change to include a mark 1304 at or toward the heel to indicate that the club sole hit the ground (e.g., lie board) toward the heel area of the club at that specific hit. Similarly, as illustrated in FIG. 13B, for a center hit, the impact tape 1300 will change to include a mark 1304 at the center to indicate that the club sole hit the ground (e.g., lie board) at the central portion of the sole at that specific hit, and as illustrated in FIG. 13C, for a toe hit, the impact tape 1300 will change to include a mark 1304 at or toward the toe to indicate that the sole hit the ground (e.g., lie board) toward the toe area of the club at that specific hit.

If desired, the fitter may simply take notice of the various impact locations at S1202. Alternatively, if desired, systems and methods according to the invention may provide a user interface that allows the user or the fitter to enter data into the system indicating the various impact locations (e.g., by providing a computer-generated user interface that allows the user or the fitter to “click on” a representation of club head face at the location of the impact). As yet another example, if an electronic club is used having an impact location determining means, the impact location may be automatically transferred to systems and methods in accordance with this invention.

Once the sole impact location for one or more shots is determined, a determination is made (by the fitter, by the system based on the input data, etc.) as to whether the impact is at the center of the sole (S1204). If no, a new lie angle may be recommended (S1206), and the user can hit additional shots using this new lie angle (S1208). This process then can return to S1202, where the sole impact location is determined for these additional hits, and the process may be repeated as often as necessary.

Although any adjustment in the lie angle at S1206 may be provided without departing from this invention, the following table or information may be used as a basis for determining the new lie angle recommendation at S1206:

Lie Angle Recommendation Changes Based on Lie Tape Mark

| Extreme Toe | Hit Toward | | Hit Toward | Extreme Heel |
|---|---|---|---|---|
| Hit | Toe | Center Hit | Heel | Hit |
| +2° (More | +1° | 0 | −1° | −2° (Flatter |
| Upright Lie) | | | | Lie) |

The process S1202-S1208 may be repeated, as necessary, until consistent central sole impact locations are observed or measured (answer “yes” at S1204). Then, this lie angle (or adjustment from a standard lie angle) may be provided as a lie angle recommendation at S1210 (e.g., for the irons or other clubs, the recommendation may indicate that each lie angle should be increased or decreased (more upright or flatter) a fixed amount from a standard lie angle for that iron or club). If desired, a report may be generated (S1212) (e.g., as a printed copy, a computer display, etc.) indicating the recommended lie angle or lie angle adjustment from standard.

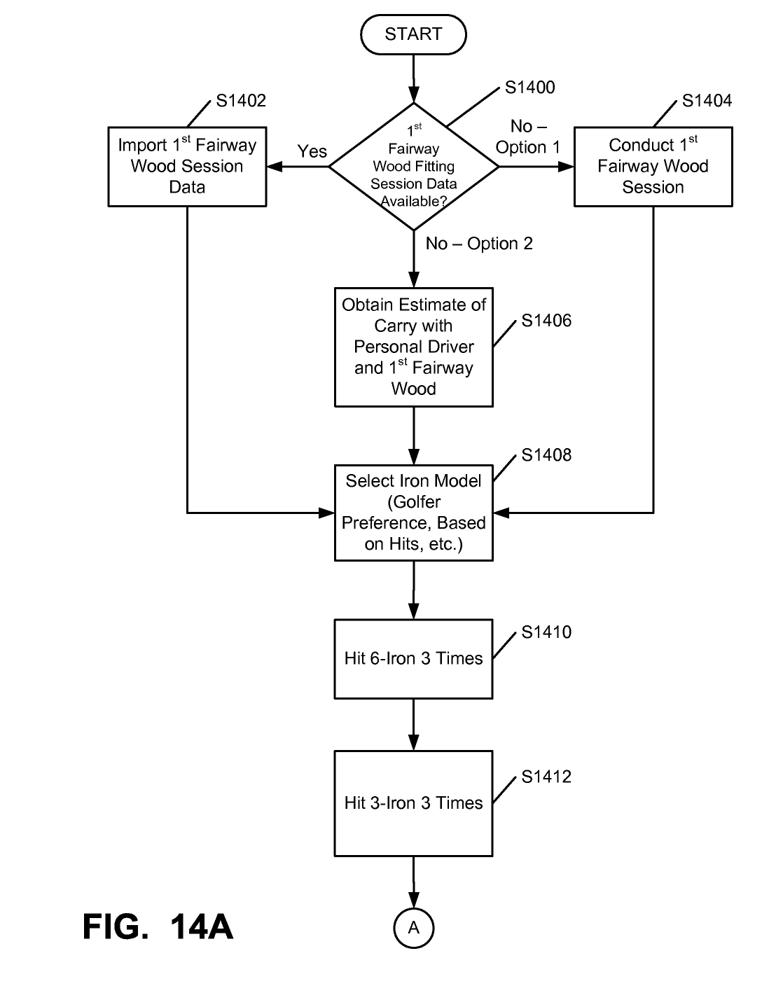

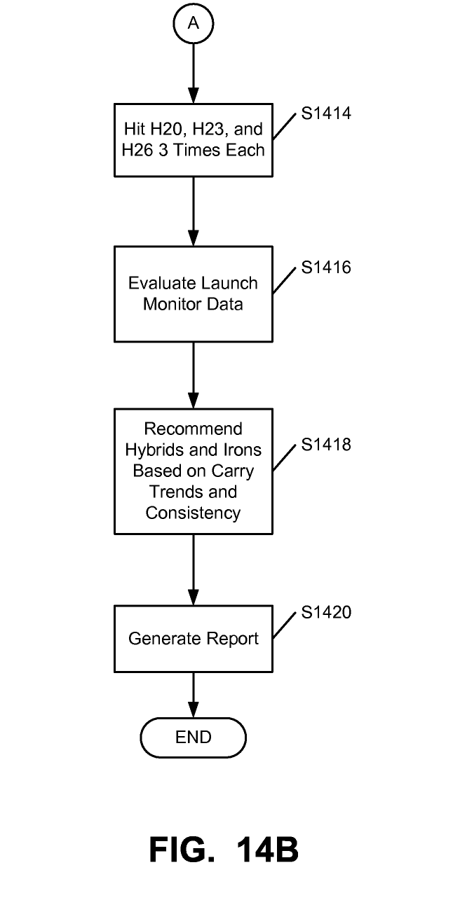

As a next or another example step in this process, as illustrated in FIGS. 14A and 14B, a second fairway wood, hybrid, and/or iron fitting process is conducted, optionally taking into account the data generated and collected above. One goal of this procedure is to try to assure that the golfer has a regular separation in distance between clubs in the bag and/or to assure that no long or wide “distance gaps” are observed between clubs in the bag. As a first step in this example process at S1400, a determination is made as to whether first fairway wood fitting session data (and fitting recommendation data) is available. If yes, this data may be retrieved or input into the system (S1402). Alternatively, if no (Option 1 in FIG. 14A), a first fairway wood fitting session may be conducted (S1404). As another alternative, if no (Option 2 in FIG. 14A), the procedure may be continued without the first fairway wood session data by obtaining an estimate of the golfer's ball carry distance using his/her personal driver and/or an estimate of the golfer's ball carry distance using his/her personal first fairway wood (S1406). If desired, the user may make some swings with his/her own clubs and the launch monitor data from these swings may be measured and used in the procedure that follows.

Once this baseline driver and/or first fairway wood data has been collected by one of the options described above, the process continues. The user then selects an iron model for his/her set (S1408), e.g., from a specific brand, from a specific manufacturer, based on one or more hits, etc. From the selected iron model, the user then hits the 6-iron a few times at S1410 (e.g., 3 times) and the 3-iron a few times at S1412 (e.g., 3 times). As shown at Step S1414 in FIG. 14B, the user also may hit some additional alternative clubs, such as a 20° hybrid, a 23° hybrid, a 26° hybrid, as well as one or more additional fairway woods, such as a 5-wood, a 7-wood, etc. Any desired number of clubs, including any desired number of hits with each club, may be used without departing from this invention. Once the hitting sessions are complete, the launch monitor data may be evaluated (S1416, e.g. as will be explained in more detail below), and recommendations can be made as to which irons, hybrids, and/or fairway woods should be included in the user's bag (S1418). If desired, a report may be generated (S1420) (e.g., as a printed copy, a computer display, etc.) indicating the recommended irons, fairway woods, and/or hybrids to be included in the user's fitted set.

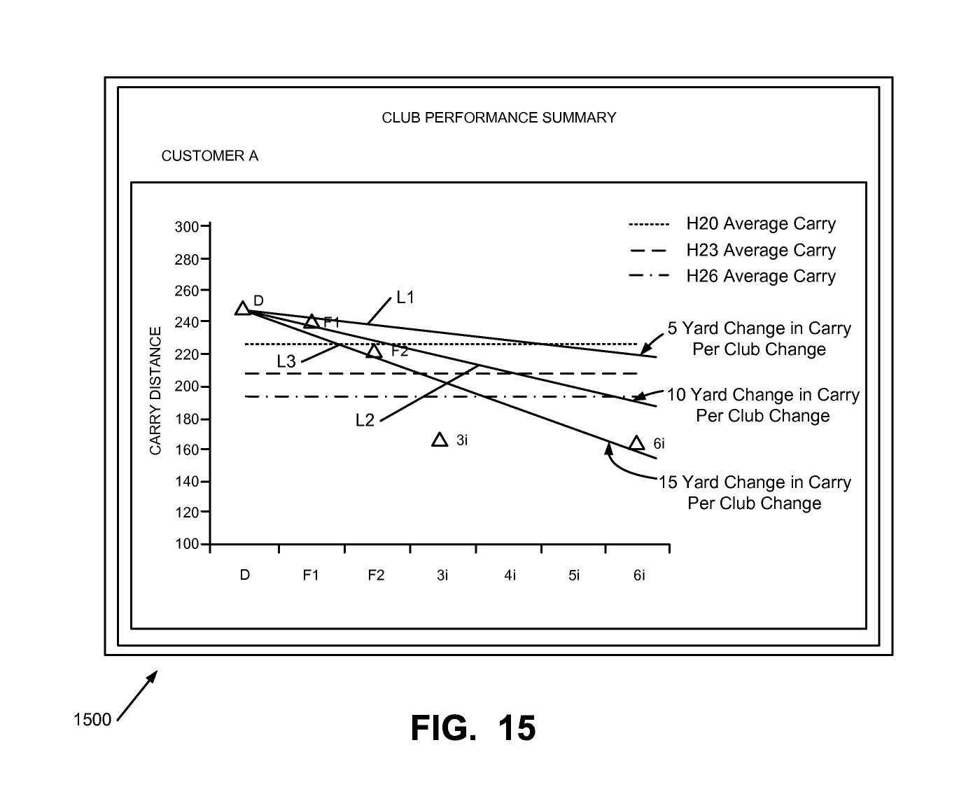

FIG. 15 illustrates a display screen 1500 (or other output) that may be used in accordance with at least some examples of this invention to evaluate the launch monitor data for the irons, hybrids, and/or fairway woods and to make recommendations as to which clubs are to be included in the fitted set. Starting with the driver D or the first fairway wood F1 data and the carry distance (or total travel distance) associated therewith as a base line, one or more sloped lines (L1, L2, and L3) are created on the display 1500 that represent a constant change in yardage (e.g., L1 at 5 yard change per club, L2 at 10 yard change per club, and L3 at 15 yard change per club). Then, the average carry distance as measured for the various clubs may be plotted, as shown, for example, for a second fairway wood (F2), the 3-iron, and the 6-iron (and/or any other iron that was hit). Ideally, the various clubs in a golfer's set will track one of the lines L1 to L3 so that the golfer will have a relatively constant change in carry distance for the clubs in the set (e.g., so that the golfer does not experience a large distance gap between adjacent clubs of his/her set). FIG. 15 illustrates that in this example fitting session, the clubs in the set fairly well tracked the constant 10-15 yard change per club lines (L2 and L3) except for the 3-iron, which had an average carry distance that fell well below the constant lines L2 and L3. This result is not surprising, because long irons typically are more difficult to hit, particularly for amateur golfers.

Because the 3-iron's average carry distance in this example left a large distance gap between clubs in the user's bag, a user might wish to consider switching out the 3-iron for a different club, such as a hybrid club or another fairway wood. The display 1500 provides information that would assist a user or club fitter in determining where such a switch may be desirable. Notably, in this instance, the display 1500 includes plots indicating the average carry distance of the various hybrid clubs, as measured during the hitting sessions described above. Looking at the average carry distance of the three tested hybrid clubs, one can see that the carry distance covered by the 23° hybrid best matches the locations on lines L2 and/or L3 within the 3-iron slot. In other words, the carry distance covered by the 23° hybrid best matches what the carry distance of the 3-iron should be, if the 3-iron were hit a sufficient distance to maintain the constant 10-15 yard distance gap between clubs in the set. Looking at this data, a club fitter may recommend replacing the 3-iron in this user's bag with the 23° hybrid. Additionally, because the carry distance covered by the 26° hybrid best matches what the carry distance of the user's 4-iron should be in order to maintain the consistent distance gap between clubs, the fitter may recommend replacing the 4-iron in the user's bag with the 26° hybrid (particularly because hybrid clubs tend to be somewhat easier to hit as compared to long irons, particularly for amateur or higher handicapped players).

Many variations in the display screen 1500 (or other output) for evaluating launch monitor data for fitting irons, hybrids, and/or fairway woods are possible without departing from this invention. For example, rather than using the fitted driver as a base starting point, systems and methods in accordance with at least some examples of this invention may use the first fairway wood (or another club) as the base starting point (e.g., the first fairway wood fitted to the user, as described above) for the iron, fairway wood, and/or hybrid fitting. Using the first fairway wood as the starting point can be more accurate, as often there is a larger distance gap between the driver and the first fairway wood as compared to the average distance gap between other consecutive clubs in the set.

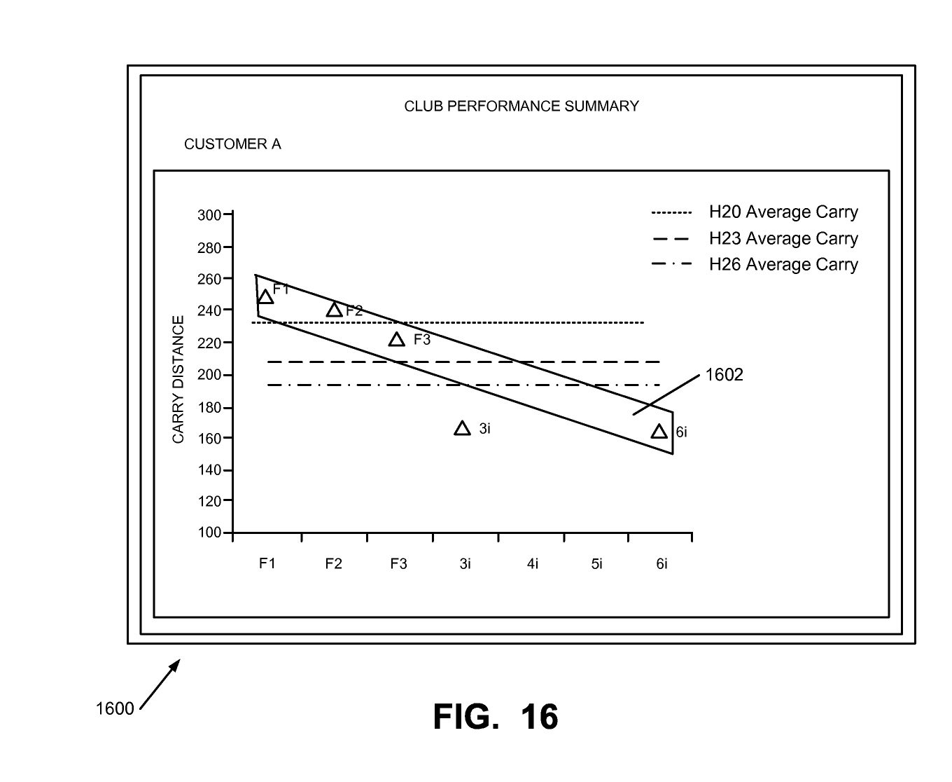

FIG. 16 shows an alternative example display screen 1600 (or other output) for evaluating launch monitor data for fitting irons, hybrids, and/or fairway woods. Rather than providing the various different club distance change lines L1 through L3, in this example display 1600, a zone 1602 of constant or desired distance change from club to club is plotted using the first fairway wood carry distance (or some other club carry distance) as the base or starting point. For example, as shown in FIG. 16, the zone 1602 may represent the carry of the 6-iron, ±5 yards, with 10-14 yards of change in carry between clubs. As another alternative, if desired, the zone 1602 may represent the first fairway wood carry distance with a change of carry distance between clubs of 12.5 yards (or other desired value), ±5 yards. In any event, these displays 1600 also clearly illustrate the manner in which the 3-iron carry distance lies well outside the zone 1602 of constant or desired carry change to produce a large distance gap between adjacent clubs in the bag. These displays 1600 also allow the user or fitter to easily see and recommend substituting a hybrid club for the 3-iron in order to better maintain a consistent distance gap between clubs in the fitted set, as described above in conjunction with FIG. 15.

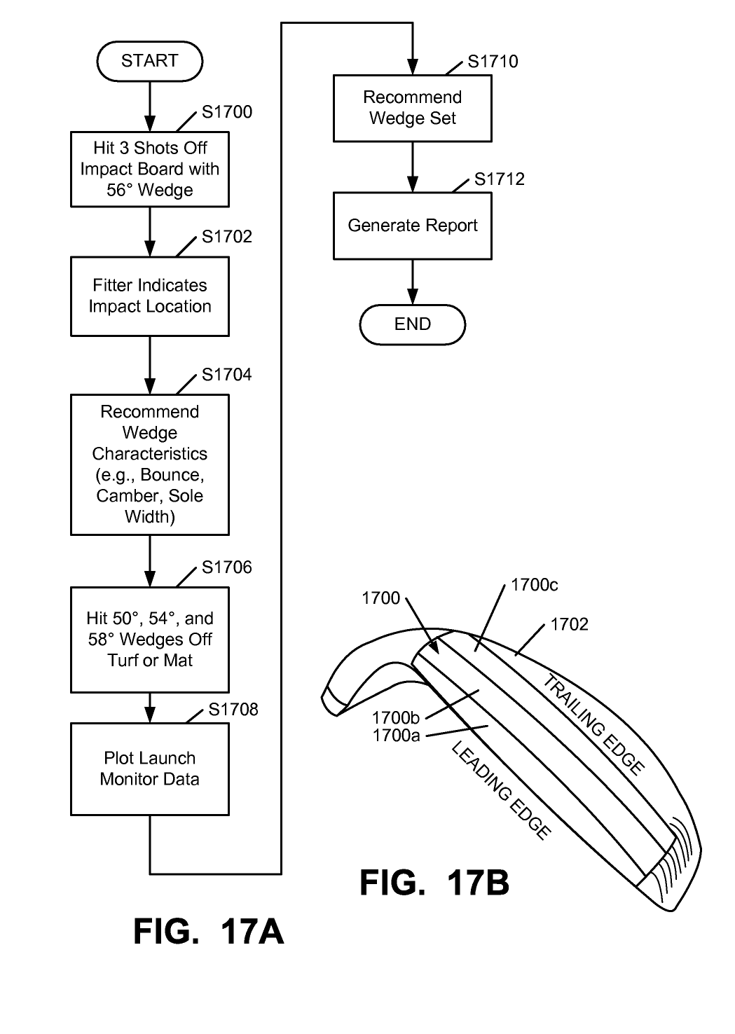

Wedge fitting is another procedure that may be included in systems and methods in accordance with at least some examples of this invention. FIG. 17A illustrates an example wedge fitting process, and FIG. 17B illustrates a club head arrangement that will aid in explanation of this fitting procedure. As this procedure starts, impact tape 1700 may be applied to the sole 1702 of a wedge, such as a 56° wedge, so that the club head's impact location with the ground (e.g. a “lie board”) may be determined (if desired, the initial wedge used for these hits may have characteristics determined, at least in part, based on the fitting procedures described above, such as lie angle adjustments, shaft length adjustments, etc.). Alternatively, rather than impact tape, other impact location point determining means may be provided, including an electronic club head having an impact location point determining system incorporated therein. Using the impact tape 1700 on the sole 1702 of the golf club (or other impact location point determining means), the user then hits some shots with the club head (S1700). For each shot, the fitter notes the impact location (S1702). For example, as illustrated in FIG. 17B, for a leading edge hit, the impact tape 1700 will change to include a mark at or toward the leading edge (in zone 1700a) to indicate that the club sole hit the ground (e.g. lie board) toward the club's leading edge for that specific hit. Similarly, for a center hit, the impact tape 1700 will change to include a mark at the center area (in zone 1700b) to indicate that the club sole hit the ground (e.g., lie board) at the central portion of the sole for that specific hit, and for a trailing edge hit, the impact tape 1700 will change to include a mark at or toward the trailing edge (in zone 1700c) to indicate that the sole hit the ground (e.g., lie board) toward the trailing edge of the club for that specific hit.

If desired, the fitter may simply take notice of the various impact locations at S1702. Alternatively, if desired, systems and methods according to the invention may provide a user interface that allows the user or the fitter to enter data into the system indicating the various impact locations (e.g., by providing a computer-generated user interface that will allow the user or the fitter to “click on” a representation of club head face at the location of the impact). As yet another example, if an electronic club is used having an impact location determining means, the impact location may be automatically transferred to systems and methods in accordance with this invention.

Given the impact locations, a determination may be made as to whether the user tends to hit down on the ball with his/her wedges and/or whether he/she tends to try to “scoop” at the ball and help it in to the air. Given this impact information, an initial set of wedge characteristics may be recommended as a starting point (S1704). These wedge characteristics may include, for example, loft angle, bounce angle, camber, sole width, wedge brand and/or model, etc. For example, the recommended wedge set may include wedges with a constant loft angle gap (e.g., 50°, 54°, 58°, etc.). Once a wedge set recommendation is made, the user may hit each recommended wedge (S1706). During these hits, a launch monitor may collect launch data relating to these hits, and this launch monitor data may be plotted (S1708), for example, as follows: ball speed v. loft; back spin v. loft; launch angle v. loft; etc. This plotted data may be output to the user, e.g., on a computer display, as a print out, etc.

Given the launch monitor data, the club fitter may recommend a wedge set (S1710), including 2 or more wedges of varying loft, bounce angle, sole width, etc., such as a sand wedge (typically having a relatively high bounce angle), a pitching wedge (with perhaps a somewhat lower bounce angle), a gap wedge, and a lob wedge. Additionally, if desired, systems and methods according to the invention may generate a report (S1712) including the wedge recommendations and/or the launch monitor data associated with this fitting procedure.

Systems and methods in accordance with at least some examples of this invention further may include a putter fitting procedure. Any desired putter fitting procedures may be used without departing from this invention, such as fittings or procedures for adjusting the putter shaft length, putter lie angle, putter loft angle, grip size and/or shape, putter head weight, putter head weight distribution, and the like. Data from the procedures described above, such as the shaft length adjustment data, lie angle adjustment data, distance between the fingertips and the ground, etc., may be used, at least in part, as a starting point for the putter fitting, e.g. to make initial recommendations for the initial putter characteristics during the fitting procedure.

Many variations in fitting systems and methods may be provided without departing from this invention, and/or many features may be added to the systems and methods, the various features may be changed in order, and the like, without departing from this invention. As a more specific example, if desired, the golf club and/or the various component parts may be equipped with features that allow the fitter to easily track and enter information regarding the construction of the club being hit by the user. For example, if desired, each club could be equipped with an RFID chip, bar code, or other data carrying and/or transmission devices, and the launch monitor or other portion of the fitting equipment may be equipped with an RFID activator, a bar code reader, and/or data receiving and/or activating devices so that fitter can easily enter data into the system regarding the club head being used (e.g., the RFID chip or bar code on the club may transmit a club identifier that enables determination of the club's characteristics, such as loft angle, shaft flex, lie characteristics, etc.).

Additionally or alternatively, if desired, the various components of the club (e.g., head, shaft, grip, etc.) may have separate RFID chips, bar codes, or other data carrying and/or transmission devices, so that data relating to each individual part of the club can be entered into and/or tracked by the system. Such separately labeled club components may be particularly useful for fitting sessions that utilize releasable connections between a club head and a shaft and/or a shaft and a grip, e.g., as described above.

### CONCLUSION

While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

1. A method for fitting a golfer with plural golf clubs, comprising:
fitting a golfer with a driver based, at least in part, on launch monitor data generated during one or more golf club hitting sessions in which the golfer hits drivers having different combinations of loft angle and shaft flexibility characteristics, wherein the driver to which the golfer is fitted includes a first loft angle and a first shaft flexibility characteristic;
selecting plural initial candidate fairway wood clubs based, at least in part, on the first loft angle and the first shaft flexibility characteristic;
hitting golf balls using the plural initial candidate fairway wood clubs and collecting launch monitor data relating to the hits correlated to the initial fairway wood club used for the hit;
optionally, selecting one or more additional candidate fairway wood clubs based, at least in part, on the launch monitor data collected when the initial fairway wood clubs were hit, and hitting golf balls using the one or more additional candidate fairway wood clubs; and
providing a recommendation for a final first fairway wood club based, at least in part, on the launch monitor data collected when one or more of the initial or additional candidate fairway wood clubs were hit.

2. A method according to claim 1, wherein the recommendation for the final first fairway wood club is based, at least in part, on an average ball carry distance determined by the launch monitor when one or more of the initial or additional candidate fairway wood clubs were hit.

3. A method according to claim 2, wherein the recommendation for the final first fairway wood club corresponds to the initial or additional candidate fairway wood club that produced a highest average ball carry distance.

4. A method according to claim 1, further comprising:
hitting golf balls using a first iron and collecting launch monitor data relating to the hits correlated to the first iron;
hitting golf balls using a first hybrid club and collecting launch monitor data relating to the hits correlated to the first hybrid club;
determining a desired carry distance or a desired carry distance range for clubs in a fitted set based, at least in part, on an average ball carry distance for at least one of the driver or the final first fairway wood club;
determining whether an average ball carry distance of the first iron or the first hybrid club better matches the desired carry distance or the desired carry distance range; and
providing a recommendation for inclusion of one of the first iron or the first hybrid club in the fitted set.

5. A method according to claim 1, further comprising:
hitting golf balls using a first iron and collecting launch monitor data relating to the hits correlated to the first iron;
hitting golf balls using a first hybrid club and collecting launch monitor data relating to the hits correlated to the first hybrid club;
hitting golf balls using a second hybrid club and collecting launch monitor data relating to the hits correlated to the second hybrid club;
determining a desired carry distance or a desired carry distance range for clubs in a fitted set based, at least in part, on an average ball carry distance for at least one of the driver or the final first fairway wood club;
determining whether an average ball carry distance of the first iron, the first hybrid club, or the second hybrid club better matches the desired carry distance or the desired carry distance range; and
providing a recommendation for inclusion of one of the first iron, the first hybrid club, or the second hybrid club in the fitted set.

6. A method according to claim 1, further comprising:
determining a desired carry distance or a desired carry distance range for clubs in a fitted set based, at least in part, on an average ball carry distance for at least one of the driver or the final first fairway wood club;
hitting golf balls using one or more irons and collecting launch monitor data relating to the hits correlated to the one or more irons;
hitting golf balls using one or more hybrid clubs and collecting launch monitor data relating to the hits correlated to the one or more hybrid clubs; and
providing a recommendation for inclusion of at least one club in the fitted set selected from the one or more irons and the one or more hybrid clubs, wherein the recommendation is based, at least in part, on the desired carry distance or the desired carry distance range for the clubs in the fitted set.

7. A method according to claim 6, wherein the recommendation for the at least one club is based, at least in part, on an average ball carry distance for the one or more irons and the one or more hybrid clubs.

8. A method according to claim 6, wherein the recommendation for the at least one club is based, at least in part, on a determination of which of the one or more irons and the one or more hybrid clubs better match the desired carry distance or the desired carry distance range for the clubs in the fitted set.

9. A method according to claim 1, further comprising:
hitting golf balls using one or more irons and collecting launch monitor data relating to the hits correlated to the one or more irons;
hitting golf balls using one or more hybrid clubs and collecting launch monitor data relating to the hits correlated to the one or more hybrid clubs; and
providing a recommendation for inclusion of at least one club in a fitted set selected from the one or more irons and the one or more hybrid clubs, wherein the recommendation for the at least one club is based, at least in part, on an average ball carry distance of the one or more irons and the one or more hybrid clubs.

10. A method according to claim 9, wherein the recommendation for the at least one club is based, at least in part, on a determination of which of the one or more irons and the one or more hybrid clubs better provide a regular change in average ball carry distance among the clubs in the fitted set.

11-46. (canceled)

47. A computer-implemented method for fitting a golfer to plural golf clubs, comprising:
receiving input data indicating a golfer's driver loft angle and at least one driver shaft flexibility characteristic;
determining plural initial candidate fairway wood clubs based, at least in part, on the driver loft angle and the driver shaft flexibility characteristic; and
outputting data identifying the selected plural initial candidate fairway wood clubs.

48. A method according to claim 47, further comprising:
receiving launch monitor data generated when the golfer hits golf balls using the plural initial candidate fairway wood clubs, wherein the launch monitor data is correlated to the initial candidate fairway wood club used for the hit.

49. A method according to claim 48, further comprising:
determining one or more additional candidate fairway wood clubs for testing based, at least in part, on the launch monitor data received based on the initial candidate fairway wood clubs hits; and
outputting data identifying the additional candidate fairway wood clubs.

50. A method according to claim 49, further comprising:
receiving launch monitor data generated when the golfer hits golf balls using the one or more additional candidate fairway wood clubs, wherein the launch monitor data is correlated to the additional candidate fairway wood club used for the hit.

51. A method according to claim 50, further comprising:
determining a recommendation for a final first fairway wood club based, at least in part, on the launch monitor data received based on one or more of the initial or additional candidate fairway wood clubs hits; and
outputting data identifying the recommendation for the final first fairway wood club.

52. A method according to claim 51, wherein the recommendation for the final first fairway wood club is based, at least in part, on an average ball carry distance included in the launch monitor data received after one or more of the initial or additional candidate fairway wood clubs were hit.

53. A method according to claim 52, wherein the recommendation for the final first fairway wood club corresponds to the initial or additional candidate fairway wood club that generated a highest average ball carry distance.

54. A method according to claim 47, further comprising:
receiving launch monitor data relating to golf ball hits using a first iron;
receiving launch monitor data relating to golf ball hits using a first hybrid club;
determining a desired carry distance or a desired carry distance range for clubs in a fitted set based, at least in part, on an average ball carry distance for at least one of the driver or a first fairway wood club;
determining whether an average ball carry distance of the first iron or the first hybrid club better matches the desired carry distance or the desired carry distance range;
determining a recommendation for inclusion of one of the first iron or the first hybrid club in the fitted set; and
outputting data indicating the recommendation for inclusion of the first iron or the first hybrid club in the fitted set.

55. A method according to claim 54, further comprising:
receiving input data for determining a shaft length for clubs in the fitted set.

56. A method according to claim 55, wherein the input data for determining the shaft length includes data indicating a distance between the golfer's fingertip and the ground when the golfer stands upright with his or her arm at his or her side.

57. A method according to claim 55, wherein the input data for determining the shaft length includes data indicating ball impact location on a face of a club when a ball is hit.

58. A method according to claim 54, further comprising:
receiving input data for determining a lie angle for clubs in the fitted set.

59. A method according to claim 58, wherein the input data for determining the lie angle includes data indicating ground impact location on a sole of a club when a ball is hit.

60. A method according to claim 47, further comprising:
receiving launch monitor data relating to golf balls hit using a first iron;
receiving launch monitor data relating to golf balls hit using a first hybrid club;
receiving launch monitor data relating to golf balls hit using a second hybrid club;
determining a desired carry distance or a desired carry distance range for clubs in a fitted set based, at least in part, on an average ball carry distance for at least one of the driver or a first fairway wood club;
determining whether an average ball carry distance of the first iron, the first hybrid club, or the second hybrid club better matches the desired carry distance or the desired carry distance range;
determining a recommendation for inclusion of at least one of the first iron, the first hybrid club, or the second hybrid club in the fitted set; and
outputting data identifying the recommendation.

61. A method according to claim 47, further comprising:
determining a desired carry distance or a desired carry distance range for clubs in a fitted set based, at least in part, on an average ball carry distance for at least one of the driver or a first fairway wood club;
receiving launch monitor data relating to golf balls hit using one or more irons;
receiving launch monitor data relating to golf balls hit using one or more hybrid clubs;
determining a recommendation for inclusion of at least one club in the fitted set selected from the one or more irons and the one or more hybrid clubs, wherein the recommendation is based, at least in part, on the desired carry distance or the desired carry distance range for the clubs in the fitted set; and
outputting data identifying the recommendation.

62. A method according to claim 61, wherein the recommendation of the at least one club is based, at least in part, on an average ball carry distance of the one or more irons and the one or more hybrid clubs.

63. A method according to claim 61, wherein the recommendation of the at least one club is based, at least in part, on a determination of which of the one or more irons and the one or more hybrid clubs better match the desired carry distance or the desired carry distance range for the clubs in the fitted set.

64. A method according to claim 61, further comprising:
receiving input data for determining a shaft length for clubs in the fitted set.

65. A method according to claim 64, wherein the input data for determining the shaft length includes data indicating a distance between the golfer's fingertip and the ground when the golfer stands upright with his or her arm at his or her side.

66. A method according to claim 64, wherein the input data for determining the shaft length includes data indicating ball impact location on a face of a club when a ball is hit.

67. A method according to claim 61, further comprising:
receiving input data for determining a lie angle for clubs in the fitted set.

68. A method according to claim 67, wherein the input data for determining the lie angle length includes data indicating ground impact location on a sole of a club when a ball is hit.

69. A method according to claim 47, further comprising:
receiving launch monitor data relating to golf balls hit using one or more irons;
receiving launch monitor data relating to golf balls hit using one or more hybrid clubs;
determining a recommendation for inclusion of at least one club in a fitted set selected from the one or more irons and the one or more hybrid clubs, wherein the recommendation of the at least one club is based, at least in part, on an average ball carry distance of the one or more irons and the one or more hybrid clubs.

70. A method according to claim 69, wherein the recommendation of the at least one club is based, at least in part, on a determination of which of the one or more irons and the one or more hybrid clubs better provide a regular change in average ball carry distance among the clubs in the fitted set.

71. A method according to claim 69, further comprising:
receiving input data for determining a shaft length for clubs in the fitted set.

72. A method according to claim 71, wherein the input data for determining the shaft length includes data indicating a distance between the golfer's fingertip and the ground when the golfer stands upright with his or her arm at his or her side.

73. A method according to claim 71, wherein the input data for determining the shaft length includes data indicating ball impact location on a face of a club when a ball is hit.

74. A method according to claim 69, further comprising:
receiving input data for determining a lie angle for clubs in the fitted set.

75. A method according to claim 74, wherein the input data for determining the lie angle includes data indicating ground impact location on a sole of a club when a ball is hit.

76. A method according to claim 47, further comprising:
receiving input data for determining a shaft length for clubs in a fitted set.

77. A method according to claim 76, wherein the input data for determining the shaft length includes data indicating a distance between the golfer's fingertip and the ground when the golfer stands upright with his or her arm at his or her side.

78. A method according to claim 76, wherein the input data for determining the shaft length includes data indicating ball impact location on a face of a club when a ball is hit.

79. A method according to claim 78, further comprising:
determining a recommendation for the shaft length based, at least in part, on the input data indicating the ball impact location on the face of the club; and
outputting data identifying the shaft length recommendation.

80. A method according to claim 47, further comprising:
receiving input data for determining a lie angle for clubs in the fitted set.

81. A method according to claim 80, wherein the input data for determining the lie angle includes data indicating ground impact location on a sole of a club when a ball is hit.

82. A method according to claim 81, further comprising:
determining a recommendation for the lie angle based, at least in part, on the input data indicating the ground impact location on the sole of the club; and
outputting data identifying the lie angle recommendation.

83. A computer-readable medium including computer-executable instructions stored thereon for performing the method described in claim 47.

84-97. (canceled)
